(19) United States
(12) Patent Application Publication
(10) Pub. No.: US 2021/0223395 A1
(43) Pub. Date: Jul. 22, 2021

(54) DETECTOR FOR OPTICALLY DETECTING AT LEAST ONE OBJECT

(71) Applicant: trinamiX GmbH, Ludwigshafen am Rhein (DE)

(72) Inventors: Sebastian VALOUCH, Ludwigshafen (DE); Robert SEND, Ludwigshafen (DE); Ingmar BRUDER, Ludwigshafen (DE); Niklas ANDERMAHR, Weinheim (DE); Andreas VOGLER, Weinheim (DE); Jean-Michel ASFOUR, Weinheim (DE)

(73) Assignee: trinamiX GmbH, Ludwigshafen am Rhein (DE)

(21) Appl. No.: 16/095,846

(22) PCT Filed: Apr. 27, 2017
(86) PCT No.: PCT/EP2017/060058

§ 371 Date: Oct. 23, 2018

(51) Int. Cl. G01S 17/06

(52) U.S. Cl. CPC G01S 17/06; G03B 13/20

(57) ABSTRACT

A detector (110) for an optical detection of at least one object (112) is disclosed. The detector (110) comprises: —at least one longitudinal optical sensor (114), wherein the longitudinal optical sensor (114) has at least one sensor region (134), wherein the longitudinal optical sensor (114) is designed to generate at least one longitudinal sensor signal in a manner dependent on an illumination of the sensor region (134) by a light beam, wherein the longitudinal sensor signal, given the same total power of the illumination, is dependent on a beam cross-section of the light beam in the sensor region (134); —at least one transfer device (128), wherein the transfer device (128) exhibits at least two different focal lengths in response to at least one incident light beam, wherein the transfer device (128) is adapted to adjust the beam cross-section of at least one first light beam (130) having a first wavelength and at least one second light beam (132) having a second wavelength different from the first wavelength depending on the wavelength of respective light beams, such that in the sensor region (134), the beam cross-section of the first light beam (130) is different from the beam cross-section of the second light beam (132); and—at least one evaluation device (156), wherein the evaluation device (156) is adapted to differentiate the longitudinal sensor signal of the longitudinal optical sensor (114) into a first longitudinal sensor signal dependent on the illumination of the sensor region (134) by the first light beam and into a second longitudinal sensor signal dependent on the illumination of the sensor region (134) by the second light beam, wherein the evaluation device (156) is designed to generate at least one item of information on a longitudinal position of the object (112) by evaluating the first longitudinal sensor signal and the second longitudinal sensor signal.

### FIELD OF THE INVENTION

The invention relates to a detector, a detector system and a method for determining a position of at least one object. The invention further relates to a human-machine interface for exchanging at least one item of information between a user and a machine, an entertainment device, a tracking system, a camera, a scanning system and various uses of the detector device. The devices, systems, methods and uses according to the present invention specifically may be employed for example in various areas of daily life, gaming, traffic technology, production technology, security technology, photography such as digital photography or video photography for arts, documentation or technical purposes, medical technology or in the sciences. However, other applications are also possible.

### PRIOR ART

A large number of optical sensors and photovoltaic devices are known from the prior art. While photovoltaic devices are generally used to convert electromagnetic radiation, for example, ultraviolet, visible or infrared light, into electrical signals or electrical energy, optical detectors are generally used for picking up image information and/or for detecting at least one optical parameter, for example, a brightness.

A large number of optical sensors which can be based generally on the use of inorganic and/or organic sensor materials are known from the prior art. Examples of such sensors are disclosed in US 2007/0176165 A1, U.S. Pat. No. 6,995,445 B2, DE 2501124 A1, DE 3225372 A1 or else in numerous other prior art documents. To an increasing extent, in particular for cost reasons and for reasons of large-area processing, sensors comprising at least one organic sensor material are being used, as described for example in US 2007/0176165 A1. In particular, so-called dye solar cells are increasingly of importance here, which are described generally, for example in WO 2009/013282 A1. The present invention, however, is not restricted to the use of organic devices. Thus, specifically, also inorganic devices such as CCD sensors and/or CMOS sensors, specifically pixelated sensors, may be employed.

A large number of detectors for detecting at least one object are known on the basis of such optical sensors. Such detectors can be embodied in diverse ways, depending on the respective purpose of use. Examples of such detectors are imaging devices, for example, cameras and/or microscopes. High-resolution confocal microscopes are known, for example, which can be used in particular in the field of medical technology and biology in order to examine biological samples with high optical resolution. Further examples of detectors for optically detecting at least one object are distance measuring devices based, for example, on propagation time methods of corresponding optical signals, for example laser pulses. Further examples of detectors for optically detecting objects are triangulation systems, by means of which distance measurements can likewise be carried out.

In WO 2012/110924 A1, the content of which is herewith included by reference, a detector for optically detecting at least one object is proposed. The detector comprises at least one optical sensor. The optical sensor has at least one sensor region. The optical sensor is designed to generate at least one sensor signal in a manner dependent on an illumination of the sensor region. The sensor signal, given the same total power of the illumination, is dependent on a geometry of the illumination, in particular on a beam cross section of the illumination on the sensor area. The detector furthermore has at least one evaluation device. The evaluation device is designed to generate at least one item of geometrical information from the sensor signal, in particular at least one item of geometrical information about the illumination and/or the object.

WO 2014/097181 A1, the full content of which is herewith included by reference, discloses a method and a detector for determining a position of at least one object, by using at least one transversal optical sensor and at least one optical sensor. Specifically, the use of sensor stacks is disclosed, in order to determine a longitudinal position of the object with a high degree of accuracy and without ambiguity.

WO 2015/024871 A1, the full content of which is herewith included by reference, discloses an optical detector, comprising:
at least one spatial light modulator being adapted to modify at least one property of a light beam in a spatially resolved fashion, having a matrix of pixels, each pixel being controllable to individually modify the at least one optical property of a portion of the light beam passing the pixel;
at least one optical sensor adapted to detect the light beam after passing the matrix of pixels of the spatial light modulator and to generate at least one sensor signal;
at least one modulator device adapted for periodically controlling at least two of the pixels with different modulation frequencies; and
at least one evaluation device adapted for performing a frequency analysis in order to determine signal components of the sensor signal for the modulation frequencies.

WO 2014/198629 A1, the full content of which is herewith included by reference, discloses a detector for determining a position of at least one object, comprising:
at least one optical sensor, the optical sensor being adapted to detect a light beam propagating from the object towards the detector, the optical sensor having at least one matrix of pixels; and
at least one evaluation device, the evaluation device being adapted to determine a number N of pixels of the optical sensor which are illuminated by the light beam, the evaluation device further being adapted to determine at least one longitudinal coordinate of the object by using the number N of pixels which are illuminated by the light beam.

EP 15 197 744.4 filed on Dec. 3, 2015, the full content of which is herewith included by reference, describes a detector for an optical detection of at least one object. The detector comprises:
at least one longitudinal optical sensor, wherein the longitudinal optical sensor has at least one sensor region, wherein the longitudinal optical sensor is designed to generate at least one longitudinal sensor signal in a manner dependent on an illumination of the sensor region by a light beam, wherein the longitudinal sensor signal, given the same total power of the illumination, is dependent on a beam cross-section of the light beam in the sensor region, wherein the longitudinal sensor signal is further dependent on at least one property of the longitudinal optical sensor, wherein the property of the longitudinal optical sensor is adjustable; and
at least one evaluation device, wherein the evaluation device is designed to generate at least one item of information on a longitudinal position of the object by evaluating the longitudinal sensor signal of the longitudinal optical sensor.

Further, generally, for various other detector concepts, reference may be made to WO 2014/198626 A1, WO 2014/198629 A1 and WO 2014/198625 A1, the full content of which is herewith included by reference. Further, referring to potential materials and optical sensors which may also be employed in the context of the present invention, reference may be made to European patent applications No. EP 15 153 215.7, filed on Jan. 30, 2015, EP 15 157 363.1, filed on Mar. 3, 2015, EP 15 164 653.6, filed on Apr. 22, 2015, EP 15177275.3, filed on Jul. 17, 2015, EP 15180354.1 and EP 15180353.3, both filed on Aug. 10, 2015, and EP 15 185 005.4, filed on Sep. 14, 2015, EP 15 196 238.8 and EP 15 196 239.6, both filed on 20 Nov. 25, 2015, EP 15 197 744.4, filed on Dec. 3, 2015, and EP 16155834.1, EP 16155835.8 and EP 16155845.7, all filed on Feb. 16, 2016, the full content of all of which is herewith also included by reference.

Despite the advantages implied by the above-mentioned devices and detectors, several technical challenges remain. Thus, generally, a need exists for detectors for detecting a position of an object in space which is both reliable and may be manufactured at low cost. Specifically, a need exists for 3D-sensing concepts. Various known concepts are at least partially based on using so-called FiP sensors, such as several of the above-mentioned concepts. For unambiguously detecting a position of an object in space 3D-sensing concepts using FiP-sensors typically rely on using at least two detectors, e.g. at least one FiP-sensor and at least one reference detector, and an optical lens, in order to have at least two different focus positions. For example, transparent detectors may be used which may be arranged stacked behind each other. Alternatively, the two detectors may be arranged such that light of a light beam splitted, e.g. by a beam splitter, impinges both the detectors. Thus, transparent detectors or an expensive beam splitter are necessary. This results in drawbacks concerning achievable quantum efficiency, signal-to-noise-ratio and optical resolution.

This discussion of known concepts, such as the concepts of several of the above-mentioned prior art documents, clearly shows that some technical challenges remain. Despite the advantages implied by the above-mentioned devices and detectors, specifically by the detector disclosed in WO 2012/110924 A1, there still is a need for improvements with respect to a simple, cost-efficient and, still, reliable spatial detector.

### Problem Addressed by the Invention

It is therefore an object of the present invention to provide devices and methods facing the above-mentioned technical challenges of known devices and methods. Specifically, it is an object of the present invention to provide devices and methods which reliably may determine a position of an object in space, preferably with a low technical effort and with low requirements in terms of technical resources and cost.

### SUMMARY OF THE INVENTION

This problem is solved by the invention with the features of the independent patent claims. Advantageous developments of the invention, which can be realized individually or in combination, are presented in the dependent claims and/or in the following specification and detailed embodiments.

As used in the following, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically will be used only once when introducing the respective feature or element. In the following, in most cases, when referring to the respective feature or element, the expressions “at least one” or “one or more” will not be repeated, non-withstanding the fact that the respective feature or element may be present once or more than once.

Further, as used in the following, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such a way with other optional or non-optional features of the invention.

In a first aspect of the present invention, a detector for an optical detection of at least one object, in particular for determining a position of at least one object, specifically with regard to a depth or to both the depth and a width of the at least one object, is disclosed.

The “object” generally may be an arbitrary object, chosen from a living object and a non-living object. Thus, as an example, the at least one object may comprise one or more articles and/or one or more parts of an article. Additionally or alternatively, the object may be or may comprise one or more living beings and/or one or more parts thereof, such as one or more body parts of a human being, e.g. a user, and/or an animal.

As used herein, the term “position” refers to at least one item of information regarding a location and/or orientation of the object and/or at least one part of the object in space. Thus, the at least one item of information may imply at least one distance between at least one point of the object and the at least one detector. As will be outlined in further detail below, the distance may be a longitudinal coordinate or may contribute to determining a longitudinal coordinate of the point of the object. Additionally or alternatively, one or more other items of information regarding the location and/or orientation of the object and/or at least one part of the object may be determined. As an example, at least one transversal coordinate of the object and/or at least one part of the object may be determined. Thus, the position of the object may imply at least one longitudinal coordinate of the object and/or at least one part of the object. Additionally or alternatively, the position of the object may imply at least one transversal coordinate of the object and/or at least one part of the object. Additionally or alternatively, the position of the object may imply at least one orientation information of the object, indicating an orientation of the object in space.

For this purpose, as an example, one or more coordinate systems may be used, and the position of the object may be determined by using one, two, three or more coordinates. As an example, one or more Cartesian coordinate systems and/or other types of coordinate systems may be used. In one example, the coordinate system may be a coordinate system of the detector in which the detector has a predetermined position and/or orientation. As will be outlined in further detail below, the detector may have an optical axis, which may constitute a main direction of view of the detector. The optical axis may form an axis of the coordinate system, such as a z-axis. Further, one or more additional axes may be provided, preferably perpendicular to the z-axis.

Thus, as an example, the detector may constitute a coordinate system in which the optical axis forms the z-axis and in which, additionally, an x-axis and a y-axis may be provided which are perpendicular to the z-axis and which are perpendicular to each other. As an example, the detector and/or a part of the detector may rest at a specific point in this coordinate system, such as at the origin of this coordinate system. In this coordinate system, a direction parallel or antiparallel to the z-axis may be regarded as a longitudinal direction, and a coordinate along the z-axis may be considered a longitudinal coordinate. An arbitrary direction perpendicular to the longitudinal direction may be considered a transversal direction, and an x- and/or y-coordinate may be considered a transversal coordinate.

Alternatively, other types of coordinate systems may be used. Thus, as an example, a polar coordinate system may be used in which the optical axis forms a z-axis and in which a distance from the z-axis and a polar angle may be used as additional coordinates. Again, a direction parallel or antiparallel to the z-axis may be considered a longitudinal direction, and a coordinate along the z-axis may be considered a longitudinal coordinate. Any direction perpendicular to the z-axis may be considered a transversal direction, and the polar coordinate and/or the polar angle may be considered a transversal coordinate.

As used herein, the detector for optical detection generally is a device which is adapted for providing at least one item of information on the position of the at least one object. The detector may be a stationary device or a mobile device. Further, the detector may be a stand-alone device or may form part of another device, such as a computer, a vehicle or any other device. Further, the detector may be a hand-held device. Other embodiments of the detector are feasible.

The detector may be adapted to provide the at least one item of information on the position of the at least one object in any feasible way. Thus, the information may e.g. be provided electronically, visually, acoustically or in any arbitrary combination thereof. The information may further be stored in a data storage of the detector or a separate device and/or may be provided via at least one interface, such as a wireless interface and/or a wire-bound interface.

The detector for an optical detection of at least one object according to the present invention comprises:
at least one longitudinal optical sensor, wherein the longitudinal optical sensor has at least one sensor region, wherein the longitudinal optical sensor is designed to generate at least one longitudinal sensor signal in a manner dependent on an illumination of the sensor region by a light beam, wherein the longitudinal sensor signal, given the same total power of the illumination, is dependent on a beam cross-section of the light beam in the sensor region;
at least one transfer device, wherein the transfer device exhibits at least two different focal lengths in response to at least one incident light beam, wherein the transfer device is adapted to adjust the beam cross-section of at least one first light beam having a first wavelength and at least one second light beam having a second wavelength different from the first wavelength depending on the wavelength of respective light beams, such that in the sensor region, the beam cross-section of the first light beam is different from the beam cross-section of the second light beam; and
at least one evaluation device, wherein the evaluation device is adapted to differentiate the longitudinal sensor signal of the longitudinal optical sensor into a first longitudinal sensor signal dependent on the illumination of the sensor region by the first light beam and into a second longitudinal sensor signal dependent on the illumination of the sensor region by the second light beam, wherein the evaluation device is designed to generate at least one item of information on a longitudinal position of the object by evaluating the first longitudinal sensor signal and the second longitudinal sensor signal.

Herein, the components listed above may be separate components. Alternatively, two or more of the components as listed above may be integrated into one component. Further, the at least one evaluation device may be formed as a separate evaluation device independent from the transfer device and the longitudinal optical sensors, but may preferably be connected to the longitudinal optical sensors in order to receive the longitudinal sensor signal. Alternatively, the at least one evaluation device may fully or partially be integrated into the longitudinal optical sensors.

As used herein, an optical sensor generally refers to a light-sensitive device for detecting a light beam, such as for detecting an illumination and/or a light spot generated by a light beam. The optical sensor may be adapted, as outlined in further detail below, to determine at least one longitudinal coordinate of the object and/or of at least one part of the object, such as at least one part of the object from which the at least one light beam travels towards the detector.

As used herein, the “longitudinal optical sensor” is generally a device which is designed to generate at least one longitudinal sensor signal in a manner dependent on an illumination of the sensor region by the light beam, wherein the longitudinal sensor signal, given the same total power of the illumination, is dependent, according to the so-called “FiP effect”, on a beam cross-section of the light beam in the sensor region. As used herein, the term “sensor signal” generally refers to an arbitrary memorable and transferable signal which is generated by the longitudinal optical sensor, in response to the illumination. The longitudinal sensor signal may generally be an arbitrary signal indicative of the longitudinal position, which may also be denoted as a depth. As an example, the longitudinal sensor signal may be or may comprise a digital and/or an ana-log signal. As an example, the longitudinal sensor signal may be or may comprise a voltage signal and/or a current signal. Additionally or alternatively, the longitudinal sensor signal may be or may comprise digital data. As an example, the sensor signal may be or may comprise at least one electronic signal, which may be or may comprise a digital electronic signal and/or an analogue electronic signal. The longitudinal sensor signal may comprise a single signal value and/or a series of signal values. The longitudinal sensor signal may further comprise an arbitrary signal which is derived by combining two or more individual signals, such as by averaging two or more signals and/or by forming a quotient of two or more signals. For potential embodiments of the longitudinal optical sensor and the longitudinal sensor signal, reference may be made to the optical sensor as disclosed in WO 2012/110924 A1. Further, either raw sensor signals may be used, or the detector, the optical sensor or any other element may be adapted to process or preprocess the sensor signal, thereby generating secondary sensor signals, which may also be used as sensor signals, such as preprocessing by filtering or the like.

As used herein, the term “light” generally refers to electromagnetic radiation in one or more of the visible spectral range, the ultraviolet spectral range and the infrared spectral range. Therein, in partial accordance with ISO standard ISO-21348, the term visible spectral range generally refers to a spectral range of 380 nm to 760 nm. The term infrared (IR) spectral range generally refers to electromagnetic radiation in the range of 760 nm to 1000 μm, wherein the range of 760 nm to 1.4 μm is usually denominated as the near infrared (NIR) spectral range, and the range from 15 μm to 1000 μm as the far infrared (FIR) spectral range. The term ultraviolet spectral range generally refers to electromagnetic radiation in the range of 1 nm to 380 nm, preferably in the range of 100 nm to 380 nm. Preferably, light as used within the present invention is visible light, i.e. light in the visible spectral range.

The term “light beam” generally refers to an amount of light emitted into a specific direction, specifically an amount of light traveling essentially in the same direction, including the possibility of the light beam having a spreading angle or widening angle. Thus, the light beam may be a bundle of the light rays having a predetermined extension in a direction perpendicular to a direction of propagation of the light beam. Preferably, the light beam may be or may comprise one or more Gaussian light beams which may be characterized by one or more Gaussian beam parameters, such as one or more of a beam waist, a Rayleigh-length or any other beam parameter or combination of beam parameters suited to characterize a development of a beam diameter and/or a beam propagation in space. The light beam propagates from the object towards the detector.

As further used herein, the term “modulated” generally refers to a periodic change of at least one property. Thus, the modulated light beam, as an example, specifically may be amplitude modulated and/or frequency modulated, using at least one modulation frequency. The modulation, as an example, may be a sinusoidal modulation or another type of modulation, such as a serrated wave modulation, a square-wave modulation, a Walsh function-type modulation, a GPS-like modulation for code multiplexing such as code division multiplex (CDM) or another type of modulation. The at least one modulation frequency, specifically, may be a fixed frequency, wherein, also, changes in modulation frequencies are feasible and may be detected.

The at least one longitudinal sensor signal, given the same total power of the illumination by the light beam, is, according to the FiP effect, dependent on a beam cross-section of the light beam in the sensor region of the at least one longitudinal optical sensor.

As used herein, the term “sensor region” generally refers to a two-dimensional or three-dimensional region which preferably, but not necessarily, is continuous and can form a continuous region, wherein the sensor region is designed to vary at least one measurable property, in a manner dependent on the illumination. By way of example, said at least one property can comprise an electrical property, for example, by the sensor region being designed to generate solely or in interaction with other elements of the optical sensor, a photovoltage and/or a photocurrent and/or some other type of signal. In particular the sensor region can be embodied in such a way that it generates a uniform, preferably a single signal in a manner dependent on the illumination of the sensor region. The sensor region can thus be the smallest unit of the longitudinal optical sensor for which a uniform signal, for example, an electrical signal, is generated, which preferably can no longer be subdivided into partial signals, for example for partial regions of the sensor region. The longitudinal optical sensor can have one or else a plurality of such sensor regions, the latter case, for example, by a plurality of such sensor regions being arranged in a two-dimensional and/or three-dimensional matrix arrangement.

The detector according to the present invention, as well as the other devices and the method proposed in the context of the present invention, specifically, may be considered as implementing a similar idea as the so-called “FiP” effect which is explained in further detail in WO 2012/110924 A1 and/or in WO 2014/097181 A1. Therein, “FiP” alludes to the effect that a signal i may be generated which, given the same total power P of the illumination, depends on the photon density, the photon flux and, thus, on the cross-section ϕ(F) of the incident beam.

As used herein, the term “beam cross-section” generally refers to a lateral extension of the light beam or a light spot generated by the light beam at a specific location. As further used herein, a light spot generally refers to a visible or detectable round or non-round illumination at a specific location by a light beam. In the light spot, the light may fully or partially be scattered or may simply be transmitted. In case a circular light spot is generated, a radius, a diameter or a Gaussian beam waist or twice the Gaussian beam waist may function as a measure of the beam cross-section. In case non-circular light-spots are generated, the cross-section may be determined in any other feasible way, such as by determining the cross-section of a circle having the same area as the non-circular light spot, which is also referred to as the equivalent beam cross-section. Within this regard, it may be possible to employ the observation of an extremum, i.e. a maximum or a minimum, of the longitudinal sensor signal, in particular a global extremum, under a condition in which the sensor region may be impinged by a light beam with the smallest possible cross-section, such as when the sensor region may be located at or near a focal point as affected by an optical lens. In case the extremum is a maximum, this observation may be denominated as the positive FiP-effect, while in case the extremum is a minimum, this observation may be denominated as the negative FiP-effect.

Given the same total power of the illumination of the sensor region by the light beam, a light beam having a first beam diameter or beam cross-section may generate a first longitudinal sensor signal, whereas a light beam having a second beam diameter or beam-cross section being different from the first beam diameter or beam cross-section generates a second longitudinal sensor signal being different from the first longitudinal sensor signal. Thus, by comparing the longitudinal sensor signals, at least one item of information on the beam cross-section, specifically on the beam diameter, may be generated. For details of this effect, reference may be made to WO 2012/110924 A1. Accordingly, the longitudinal sensor signals generated by the longitudinal optical sensors may be compared, in order to gain information on the total power and/or intensity of the light beam and/or in order to normalize the longitudinal sensor signals and/or the at least one item of information on the longitudinal position of the object for the total power and/or total intensity of the light beam. Thus, as an example, a maximum value of the longitudinal optical sensor signals may be detected, and all longitudinal sensor signals may be divided by this maximum value, thereby generating normalized longitudinal optical sensor signals, which, then, may be transformed by using the above-mentioned known relationship, into the at least one item of longitudinal information on the object. Other ways of normalization are feasible, such as a normalization using a mean value of the longitudinal sensor signals and dividing all longitudinal sensor signals by the mean value. Other options are possible. Each of these options may be appropriate to render the transformation independent from the total power and/or intensity of the light beam. In addition, information on the total power and/or intensity of the light beam might, thus, be generated.

Specifically in case one or more beam properties of the light beam propagating from the object to the detector are known, the at least one item of information on the longitudinal position of the object may thus be derived from a known relationship between the at least one longitudinal sensor signal and a longitudinal position of the object. The known relationship may be stored in the evaluation device as an algorithm and/or as one or more calibration curves. As an example, specifically for Gaussian beams, a relationship between a beam diameter or beam waist and a position of the object may easily be derived by using the Gaussian relationship between the beam waist and a longitudinal coordinate.

The detector comprises at least one transfer device, such as an optical lens, which will be described later in more detail, and which may further be arranged along a common optical axis. Most preferably, the light beam which emerges from the object may in this case travel first through the at least one transfer device and thereafter to the longitudinal optical sensor. As used herein, the term “transfer device” refers to an optical element which is configured to transfer the at least one light beam emerging from the object to optical sensors within the detector, i.e. the at least one longitudinal optical sensor and the at least one optional transversal optical sensor. Thus, the transfer device can be designed to feed light propagating from the object to the detector to the optical sensors, wherein this feeding can optionally be effected by means of imaging or else by means of non-imaging properties of the transfer device. In particular the transfer device can also be designed to collect the electromagnetic radiation before the latter is fed to the transversal and/or longitudinal optical sensor.

In addition, the at least one transfer device may have imaging properties. Consequently, the transfer device comprises at least one imaging element, for example at least one lens and/or at least one curved mirror, since, in the case of such imaging elements, for example, a geometry of the illumination on the sensor region can be dependent on a relative positioning, for example a distance, between the transfer device and the object. The transfer device may be designed in such a way that the electromagnetic radiation which emerges from the object is transferred completely to the sensor region, for example is focused completely onto the sensor region, in particular the sensor area, in particular if the object is arranged in a visual range of the detector.

According to the present invention, the transfer device exhibits at least two different focal lengths in response to at least one incident light beam, wherein, in particular, the different focal lengths of the transfer device differ with respect to a wavelength of the at least one incident light beam. As used herein, the term “focal length” of the transfer device refers to a distance over which incident collimated rays which may impinge the transfer device are brought into a focus which may also be denoted as “focal point”. Thus, the focal length constitutes a measure of an ability of the transfer device to converge an impinging light beam. Thus, the transfer device may comprise one or more imaging elements which can have the effect of a converging lens. By way of example, the transfer device can have one or more lenses, in particular one or more refractive lenses, and/or one or more convex mirrors. In this example, the focal length may be defined as a distance from the center of the thin refractive lens to the principal focal points of the thin lens. For a converging thin refractive lens, such as a convex or biconvex thin lens, the focal length may be considered as being positive and may provide the distance at which a beam of collimated light impinging the thin lens as the transfer device may be focused into a single spot. Additionally, the transfer device can comprise at least one wavelength-selective element, for example at least one optical filter. Additionally, the transfer device can be designed to impress a predefined beam profile on the electromagnetic radiation, for example, at the location of the sensor region and in particular the sensor area. The above-mentioned optional embodiments of the transfer device can, in principle, be realized individually or in any desired combination.

As already mentioned, the transfer device is adapted to adjust the beam cross-section of the first light beam having the first wavelength and the second light beam having the second wavelength different from the first wavelength depending on the wavelength of respective light beams, such that in the sensor region, the beam cross-section of the first light beam is different from the beam cross-section of the second light beam. The transfer device exhibit at least two different focal lengths dependent on the wavelength of at least one incident light beam. The transfer device may comprise one or more optical lenses having a wavelength dependent refractive index. Particularly in the case where the transfer device comprises a refractive lens, the different focal lengths in the transfer device may be created by a chromatic aberration caused by a material used in the transfer device. The transfer device may be or may comprise a lens with strong chromatic aberration. As used herein, the term “adjust the beam cross-section” generally refers to affecting at least one light beam impinging on the transfer device for the purpose of at least one of configuring, changing, modifying, varying the beam cross-section of the light beam. The transfer device may be adapted to separate the first light beam and second light beam depending on the wavelength of the light beam, such that the beam cross-section of the light beams in the sensor region is different. Further, the first light beam and the second light beam may be generated as separated and/or independent light beams. For example, the first light beam and the second light beam may be generated by at least two illumination sources or by at least one illumination source having at least two light sources. For example, the first light beam and the second light beam may be portions of one light beam, e.g. generated by at least one illumination source, wherein the light beam comprises at least one first portion and at least one second portion having different wavelengths. For example, at least one light beam may impinge on the transfer device. The transfer device may be adapted to separate a portion of the light beam having the first wavelength from a portion of the light beam having the second wavelength, such that the portion of the light beam having the first wavelength has the first beam cross-section in the sensor region and the portion of the light beam having the second wavelength has the second beam cross-section different from the first beam cross-section in the sensor region. Thus, in other words, the transfer device may be adapted to adjust the beam cross-section of the portion having the first wavelength and the portion having the second wavelength, such that the portion having the first wavelength creates a spot with a different spot size in the sensor region than the portion having the second wavelength. In another embodiment, two light beams having two different wavelengths may impinge in the transfer device. The transfer device may be adapted to separate the light beam having the first wavelength from the light beam having the second wavelength, such that the light beam having the first wavelength has the first beam cross-section in the sensor region and the light beam having the second wavelength has the second beam cross-section different from the first beam cross-section in the sensor region.

As outlined above, the evaluation device is adapted to differentiate, for example to separate and/or to assign, the longitudinal sensor signal of the longitudinal optical sensor into a first longitudinal sensor signal dependent on the illumination of the sensor region by the first light beam and a second longitudinal sensor signal dependent on the illumination of the sensor region by the second light beam, wherein the evaluation device is designed to generate at least one item of information on a longitudinal position of the object by evaluating the first longitudinal sensor signal and the second longitudinal sensor signal. As used herein, the term “evaluation device” generally refers to an arbitrary device designed to generate the items of information, i.e. the at least one item of information on the position of the object. As an example, the evaluation device may be or may comprise one or more integrated circuits, such as one or more application-specific integrated circuits (ASICs), and/or one or more data processing devices, such as one or more computers, preferably one or more microcomputers and/or microcontrollers. Additional components may be comprised, such as one or more preprocessing devices and/or data acquisition devices, such as one or more devices for receiving and/or preprocessing of the sensor signals, such as one or more AD-converters and/or one or more filters. As used herein, the sensor signal may generally refer to one of the longitudinal sensor signals and, if applicable, to a transversal sensor signal. Further, the evaluation device may comprise one or more data storage devices. Further, as outlined above, the evaluation device may comprise one or more interfaces, such as one or more wireless interfaces and/or one or more wire-bound interfaces.

The at least one evaluation device may be adapted to perform at least one computer program, such as at least one computer program performing or supporting the step of generating the items of information. As an example, one or more algorithms may be implemented which, by using the sensor signals as input variables, may perform a predetermined transformation into the position of the object.

The evaluation device may particularly comprise at least one data processing device, in particular an electronic data processing device, which can be designed to generate the items of information by evaluating the sensor signals. Thus, the evaluation device is designed to use the sensor signals as input variables and to generate the items of information on the transversal position and the longitudinal position of the object by processing these input variables. The processing can be done in parallel, subsequently or even in a combined manner. The evaluation device may use an arbitrary process for generating these items of information, such as by calculation and/or using at least one stored and/or known relationship. Besides the sensor signals, one or a plurality of further parameters and/or items of information can influence said relationship, for example at least one item of information about a modulation frequency. The relationship can be determined or determinable empirically, analytically or else semi-empirically. The relationship may comprise at least one calibration curve, at least one set of calibration curves, at least one function or a combination of the possibilities mentioned. One or a plurality of calibration curves can be stored for example in the form of a set of values and the associated function values thereof, for example in a data storage device and/or a table. Alternatively or additionally, however, the at least one calibration curve can also be stored for example in parameterized form and/or as a functional equation. Separate relationships for processing the sensor signals into the items of information may be used. Alternatively, at least one combined relationship for processing the sensor signals is feasible. Various possibilities are conceivable and can also be combined.

By way of example, the evaluation device can be designed in terms of programming for the purpose of determining the items of information. The evaluation device can comprise in particular at least one computer, for example at least one microcomputer. Furthermore, the evaluation device can comprise one or a plurality of volatile or nonvolatile data memories. As an alternative or in addition to a data processing device, in particular at least one computer, the evaluation device can comprise one or a plurality of further electronic components which are designed for determining the items of information, for example an electronic table and in particular, at least one look-up table and/or at least one application-specific integrated circuit (ASIC).

The detector has, as described above, at least one evaluation device. In particular, the at least one evaluation device can also be designed to completely or partly control or drive the detector, for example by the evaluation device being designed to control at least one illumination source and/or to control at least one modulation device of the detector. The evaluation device can be designed, in particular, to carry out at least one measurement cycle in which one or a plurality of sensor signals, such as a plurality of sensor signals, are picked up, for example a plurality of sensor signals of successively, at different modulation frequencies of the illumination.

The evaluation device is designed, as described above, to generate at least one item of information on the position of the object by evaluating the at least one sensor signal. Said position of the object can be static or may even comprise at least one movement of the object, for example a relative movement between the detector or parts thereof and the object or parts thereof. In this case, a relative movement can generally comprise at least one linear movement and/or at least one rotational movement. Items of movement information can for example also be obtained by comparison of at least two items of information picked up at different times, such that, for example at least one item of location information can also comprise at least one item of velocity information and/or at least one item of acceleration information, for example at least one item of information about at least one relative velocity between the object or parts thereof and the detector or parts thereof. In particular, the at least one item of location information can generally be selected from: an item of information about a distance between the object or parts thereof and the detector or parts thereof, in particular an optical path length; an item of information about a distance or an optical distance between the object or parts thereof and the optional transfer device or parts thereof; an item of information about a positioning of the object or parts thereof relative to the detector or parts thereof; an item of information about an orientation of the object and/or parts thereof relative to the detector or parts thereof; an item of information about a relative movement between the object or parts thereof and the detector or parts thereof; an item of information about a two-dimensional or three-dimensional spatial configuration of the object or of parts thereof, in particular a geometry or form of the object. Generally, the at least one item of location information can therefore be selected, for example from the group consisting of: an item of information about at least one location of the object or at least one part thereof; information about at least one orientation of the object or a part thereof; an item of information about a geometry or form of the object or of a part thereof, an item of information about a velocity of the object or of a part thereof, an item of information about an acceleration of the object or of a part thereof, an item of information about a presence or absence of the object or of a part thereof in a visual range of the detector.

The at least one item of location information can be specified, for example in at least one coordinate system, for example a coordinate system in which the detector or parts thereof rest. Alternatively or additionally, the location information can also simply comprise, for example a distance between the detector or parts thereof and the object or parts thereof. Combinations of the possibilities mentioned are also conceivable.

The evaluation device may be adapted to generate the at least one item of information on the longitudinal position of the object by determining a diameter of the light beam from the at least one longitudinal sensor signal. For further details with regard to determining the at least one item of information on the longitudinal position of the object by employing the evaluation device according to the present invention, reference may made to the description in WO 2014/097181 A1. Thus, generally, the evaluation device may be adapted to compare the beam cross-section and/or the diameter of the light beam with known beam properties of the light beam in order to determine the at least one item of information on the longitudinal position of the object, preferably from a known dependency of a beam diameter of the light beam on at least one propagation coordinate in a direction of propagation of the light beam and/or from a known Gaussian profile of the light beam. For example, the illumination source may be adapted to adjust the opening angle of the light beams to a pre-determined opening angle, such that the beam diameter of the light beam is known at the location of the illumination source and/or of one or more apertures of the illumination source.

The evaluation device may be designed to differentiate the first longitudinal sensor signal and the second longitudinal sensor signal by one or more of a modulation, a frequency or phase shift. Thus, the evaluation device may be designed to separate and/or determine the portion of the longitudinal sensor signal generated by the first light beam and the portion of the longitudinal sensor signal generated by the second light beam. For example, the light beams may be modulated light beams, wherein the light beams may be modulated with different modulation frequencies. The detector may be designed to detect at least two longitudinal sensor signals in the case of different modulations, in particular at least two sensor signals at respectively different modulation frequencies. The longitudinal optical sensor may be designed in such a way that the longitudinal sensor signal, given the same total power of the illumination, is dependent on a modulation frequency of a modulation of the illumination. The longitudinal sensor signal may comprise a first portion dependent on a modulation frequency of the first light beam and a second portion dependent on a modulation frequency of the second light beam. The evaluation device may be designed to distinguish and/or separate and/or determine the portion of the longitudinal sensor signal generated by the first light beam and the portion of the longitudinal sensor signal generated by the second light beam.

The evaluation device may be designed to generate the at least one item of information on the longitudinal position of the object by evaluating the at least two longitudinal sensor signals. The evaluation device may be adapted to generate the at least one item of information on the longitudinal position of the object by determining a diameter of the light beam from the at least one longitudinal sensor signal.

The evaluation device may be designed to resolve ambiguities by considering the first longitudinal sensor signal and the second longitudinal sensor signal. The evaluation device may be designed to evaluate the longitudinal optical sensor signal unambiguously. The evaluation device may be configured to resolve an ambiguity in the known relationship between a beam cross-section of the light beam and the longitudinal position of the object. Thus, even if the beam properties of the light beam propagating from the object to the detector are known fully or partially, it is known that, in many beams, the beam cross-section narrows before reaching a focal point and, afterwards, widens again. Thus, before and after the focal point in which the light beam has the narrowest beam cross-section, positions along the axis of propagation of the light beam occur in which the light beam has the same cross-section. Thus, as an example, at a distance z0 before and after the focal point, the cross-section of the light beam is identical.

In this context, reference can be made to European patent application number 15191960.2 filed on Oct. 28, 2015, the full content of which is herewith included by reference. In case only one longitudinal optical sensor with a specific spectral sensitivity is used, a specific cross-section of the light beam might be determined, in case the overall power or intensity of the light beam is known. By using this information, the distance z0 of the respective longitudinal optical sensor from the focal point might be determined. However, in order to determine whether the respective longitudinal optical sensor is located before or behind the focal point, additional information is required, such as a history of movement of the object and/or the detector and/or information on whether the detector is located before or behind the focal point. In typical situations, this additional information may not be provided. Thus, to resolve ambiguities, the detector may comprise at least two longitudinal optical sensors. However, especially in view of cost-efficiency and space requirements, it may be desirable to determine the at least one item of information on the longitudinal position of the object without ambiguities by using a single longitudinal optical sensor. Thus, the detector may comprise one longitudinal optical sensor. Thus, according to the present invention at least one transfer device is disclosed which exhibits at least two different focal lengths in response to at least one incident light beam, wherein the transfer device is adapted to adjust the beam cross-section of at least one first light beam having a first wavelength and at least one second light beam having a second wave-length different from the first wavelength depending on the wavelength of respective light beams, such that in the sensor region the beam cross-section of the first light beam is different from the beam cross-section of the second light beam. By generating two light beams with different, in particular pre-determined beam cross-sections may allow resolving ambiguities. The first light beam and the second light beam impinging on the sensor region of the longitudinal optical sensor have different beam cross-sections and may generate two spots on the longitudinal optical sensor region having different sizes, e.g. different diameters. The longitudinal optical sensor may generate a longitudinal sensor signal which depends on and/or is generated by the illumination of the sensor region by the first and the second light beam. The longitudinal sensor signal may comprise a first portion dependent on and/or generated by the illumination of the sensor region by the first light beam. The longitudinal sensor signal may comprise a second portion dependent on and/or generated by the illumination of the sensor region by the second light beam. The evaluation device may be adapted to separate and/or determine the first and the second portion and to generate at least one item of information on a longitudinal position of the object by evaluating both portions of the longitudinal sensor signal. Thus, the evaluation device may be adapted to determine additional information whether the longitudinal optical sensor is located before or behind the focal point from the first and the second portion of the longitudinal sensor signal. For example, the evaluation device may be adapted to compare the portions of the longitudinal sensor signal and to determine whether the longitudinal optical sensor is located before or behind the focal point from the first and the second portion of the longitudinal sensor signal.

In case the evaluation device, by evaluating the portions of the longitudinal sensor signal, recognizes that the beam cross-section of the first light beam is larger than the beam cross-section of the second light beam, wherein the transfer device has a shorter focal length for the first wavelength than for the second wavelength, the evaluation device may determine that the first light beam is widening whereas the second light beam is still narrowing and that the location of the longitudinal optical sensor is situated behind the focal point of the first light beam and before the focal point of the second light beam. Contrarily, in case the beam cross-section of the first light beam is smaller than the beam cross-section of the second light beam, the evaluation device may determine that the light beams are still narrowing and that the location of the longitudinal optical sensor is situated before the focal points. Generally, the evaluation device may be adapted to recognize whether the light beam widens or narrows, by comparing the portions of the longitudinal sensor signal generated by the first light beam and the second light beam.

The evaluation device may be configured to perform an analysis of the longitudinal sensor signal, in particular a curve analysis of the longitudinal sensor signal. The evaluation device may be configured to determine the amplitude of the longitudinal sensor signal. The evaluation device may be designed to determine the amplitude of the first longitudinal sensor signal and the second longitudinal sensor signal. The evaluation device may be configured to evaluate the first and second longitudinal sensor signals simultaneously. The evaluation device may be configured to resolve ambiguities by comparing the first and second longitudinal sensor signal. The evaluation device may be adapted to normalize the longitudinal sensor signal and to generate the information on the longitudinal position of the object independent from an intensity of the light beam. The first and second longitudinal sensor signals may be compared, in order to gain information on the total power and/or intensity of the light beam and/or in order to normalize the longitudinal sensor signal and/or the at least one item of information on the longitudinal position of the object for the total power and/or total intensity of the light beams.

The detector further may comprise at least one illumination source adapted to emit at least one light beam. The illumination source may be adapted to emit at least one light beam comprising at least two different wavelengths, wherein the light beam may comprise at least one first portion and at least one second portion having different wavelengths. The illumination source may be adapted to emit at least two light beams having different wavelengths. The detector may comprise at least one illumination source adapted to emit at least one first light beam and at least one second light beam. The illumination source may comprise at least two light sources. Thus, one or more illumination sources might be provided which illuminate the object, such as by using one or more primary rays or beams, such as one or more primary rays or beams having a predetermined characteristic. In the latter case, the light beam propagating from the object to the detector might be a light beam which is reflected by the object and/or a reflection device connected to the object.

As used herein, an “illumination source” generally refers to an arbitrary device designed to generate and to emit at least one light beam. The illumination source can be embodied in various ways. Thus, the illumination source can be, for example, part of the detector in a detector housing. Alternatively or additionally, however, the at least one illumination source can also be arranged outside a detector housing, for example as a separate light source. The illumination source can be arranged separately from the object and illuminate the object from a distance. Alternatively or additionally, the illumination source can also be connected to the object or even be part of the object, such that, by way of example, the electromagnetic radiation emerging from the object can also be generated directly by the illumination source. By way of example, at least one illumination source can be arranged on and/or in the object and directly generate the electromagnetic radiation by means of which the sensor region is illuminated. The illumination source can for example be or comprise an ambient light source and/or may be or may comprise an artificial illumination source. By way of example, at least one infrared emitter and/or at least one emitter for visible light and/or at least one emitter for ultraviolet light can be arranged on the object. By way of example, at least one light emitting diode and/or at least one laser diode can be arranged on and/or in the object. The illumination source can comprise in particular one or a plurality of the following illumination sources: a laser, in particular a laser diode, although in principle, alternatively or additionally, other types of lasers can also be used; a light emitting diode; an incandescent lamp; a neon light; a flame source; an organic light source, in particular an organic light emitting diode; a structured light source. Alternatively or additionally, other illumination sources can also be used. It is particularly preferred if the illumination source is designed to generate one or more light beams having a Gaussian beam profile, as is at least approximately the case, for example, in many lasers. For further potential embodiments of the optional illumination source, reference may be made to one of WO 2012/110924 A1 and WO 2014/097181 A1. Still, other embodiments are feasible.

The illumination source may comprise an artificial illumination source, in particular at least one laser source and/or at least one incandescent lamp and/or at least one semiconductor light source, for example, at least one light-emitting diode, in particular an organic and/or inorganic light-emitting diode. On account of their generally defined beam profiles and other properties of handleability, the use of at least one laser source as the illumination source is particularly preferred. For example, the illumination source may comprise two laser sources, wherein each of the laser sources may be adapted to generate light beams having different or equal wavelengths. The illumination source may emit at least two laser beams. The light beams may be diverging laser beams. One or both of the light beams may be diverging light beams such that a beam diameter of one or both of the light beams increases with distance from an aperture of the illumination source. The light beams may have different beam divergences.

For example, the illumination source may be connected to the object or even be part of the object, such that, by way of example, the electromagnetic radiation emerging from the object can also be generated directly by the illumination source. Alternatively, the illumination source, e.g. each of the laser beams, may be configured for the illumination of a single dot located on at least one projection surface, e.g. which may be connected to the object or even be part of the object.

The at least one optional illumination source generally may emit light in at least one of: the ultraviolet spectral range, preferably in the range of 200 nm to 380 nm; the visible spectral range (380 nm to 780 nm); the infrared spectral range, preferably in the range of 780 nm to 3.0 micrometers. Most preferably, the at least one illumination source is adapted to emit light in the visible spectral range, preferably in the range of 500 nm to 780 nm, most preferably at 650 nm to 750 nm or at 690 nm to 700 nm. Herein, it is particularly preferred when the illumination source may exhibit a spectral range which may be related to the spectral sensitivities of the longitudinal sensors, particularly in a manner to ensure that the longitudinal sensor, which may be illuminated by the respective illumination source, may provide a sensor signal with a high intensity which may, thus, enable a high-resolution evaluation with a sufficient signal-to-noise-ratio.

The illumination source may comprise a first light source and a second light source, wherein the first light source is adapted to emit the first light beam and the second light source is adapted to emit the second light beam. For example, the illumination source may comprise at least two light sources, e.g. two or more LEDs or laser sources. The illumination source may comprise one of a bi-color target adapted to emit light with two different wavelengths or a multi-color target adapted to emit light with a plurality of wavelengths.

The illumination source may comprise at least one aperture element. The aperture element may be a light emitting aperture element. As generally used, the term “aperture element” refers to an optical element of the illumination source which is placed on a beam path of an incident light beam which, subsequently, impinges on the optical sensor, wherein the aperture element may only allow a portion of the incident light beam to pass through while the other portions of the incident light beam are stopped and/or reflected, such as to one or more targets outside the optical sensor. As a result, the term “aperture element” may, thus, refer to an optical element having an opaque body and an opening inserted into the opaque body, wherein the opaque body may be adapted to stop a further passage of the incident light beam and/or to reflect the light beam while that portion of the incident light which may impinge on the opening, usually denoted as the “aperture”, can pass through the aperture element. Thus, the aperture element may also be denominated as a “diaphragm” or a “stop”.

The illumination source may be adapted to emit light in at least two different wavelengths. For example, the illumination source may be configured to switch between emitting light in at least one first wavelength and emitting light in at least one second wavelength and/or the illumination source may comprise two light sources emitting light in different wavelengths. For example, the illumination source may comprise at least one light source adapted to emit light in different wavelengths, wherein the wavelength of the emitted light beam may be adjustable, for example by an external influence. For example, the illumination source may comprise at least two light sources, wherein the at least two light sources are configured to emit light in different wavelengths. Thus, a first light source may provide a light beam having a first wavelength and a second light source may provide a light beam having a second wavelength. The first light beam and the second light beam may be emitted simultaneously or sequentially. For example, in case the illumination source comprises two light sources, the first light source providing the first light beam may stay switched on, while the second light source may provide the second light beam.

For example, the first wavelength may be a short wavelength compared to the second wavelength. In particular the first wavelength may be in the visible spectral range, preferably in the range of 380 to 450 nm, more preferably in the range of 390 to 420 nm, most preferably in the range of 400 to 410 nm. For example, the second wavelength may be in the visible spectral range as well, preferably in the range of 500 to 560 nm, more preferably in the range of 510 to 550 nm, most preferably in the range of 520 to 540 nm.

The first light beam and the second light beam may be emitted simultaneously or sequentially

Furthermore the detector may have at least one modulation device for modulating the illumination, in particular for a periodic modulation, in particular a periodic beam interrupting device. A modulation of the illumination should be understood to mean a process in which a total power of the illumination is varied, preferably periodically, in particular with one or a plurality of modulation frequencies. In particular, a periodic modulation can be effected between a maximum value and a minimum value of the total power of the illumination. The minimum value can be 0, but can also be >0, such that, by way of example, complete modulation does not have to be effected. The modulation can be effected for example in a beam path between the object and the optical sensor, for example by the at least one modulation device being arranged in said beam path. Alternatively or additionally, however, the modulation can also be effected in a beam path between an optional illumination source—described in even greater detail below—for illuminating the object and the object, for example by the at least one modulation device being arranged in said beam path. A combination of these possibilities is also conceivable. The at least one modulation device can comprise for example a beam chopper or some other type of periodic beam interrupting device, for example comprising at least one interrupter blade or interrupter wheel, which preferably rotates at constant speed and which can thus periodically interrupt the illumination. Alternatively or additionally, however, it is also possible to use one or a plurality of different types of modulation devices, for example modulation devices based on an electro-optical effect and/or an acousto-optical effect. Once again alternatively or additionally, the at least one optional illumination source itself can also be designed to generate a modulated illumination, for example by said illumination source itself having a modulated intensity and/or total power, for example a periodically modulated total power, and/or by said illumination source being embodied as a pulsed illumination source, for example as a pulsed laser. Thus, by way of example, the at least one modulation device can also be wholly or partly integrated into the illumination source. Various possibilities are conceivable.

Accordingly, the detector can be designed in particular to detect at least two longitudinal sensor signals in the case of different modulations, in particular at least two longitudinal sensor signals at respectively different modulation frequencies. The evaluation device can be designed to generate the geometrical information from the at least two longitudinal sensor signals. As described in WO 2012/110924 A1 and WO 2014/097181 A1, it is possible to resolve ambiguities and/or it is possible to take account of the fact that, for example, a total power of the illumination is generally unknown. By way of example, the detector can be designed to bring about a modulation of the illumination of the object and/or at least one sensor region of the detector, such as at least one sensor region of the at least one longitudinal optical sensor, with a frequency of 0.05 Hz to 1 MHz, such as 0.1 Hz to 10 kHz. As outlined above, for this purpose, the detector may comprise at least one modulation device, which may be integrated into the at least one optional illumination source and/or may be independent from the illumination source. Thus, at least one illumination source might, by itself, be adapted to generate the above-mentioned modulation of the illumination, and/or at least one independent modulation device may be present, such as at least one chopper and/or at least one device having a modulated transmissibility, such as at least one electro-optical device and/or at least one acousto-optical device.

For example, the first light beam and the second light beam may be modulated light beams. The detector may be designed to detect at least two longitudinal sensor signals in the case of different modulations, in particular at least two sensor signals at respectively different modulation frequencies, wherein the evaluation device may be designed to generate the at least one item of information on the longitudinal position of the object by evaluating the at least two longitudinal sensor signals. The longitudinal optical sensor may be furthermore designed in such a way that the longitudinal sensor signal, given the same total power of the illumination, is dependent on a modulation frequency of a modulation of the illumination.

According to the present invention, it may be advantageous to apply at least one modulation frequency to the optical detector as described above. However, it may still be possible to directly determine the longitudinal sensor signal without applying a modulation frequency to the optical detector. An application of a modulation frequency may not be required under many relevant circumstances in order to acquire the desired longitudinal information about the object. As a result, the optical detector may, thus, not be required to comprise a modulation device which may further contribute to the simple and cost-effective setup of the spatial detector. As a further result, a spatial light modulator may be used in a time-multiplexing mode rather than a frequency-multiplexing mode or in a combination thereof.

The modulation device may be adapted to modulate the illumination such that the first light beam and the second light beam have a phase shift. For example, a periodic signal may be used for the light source modulation. For example, the phase shift may be 180° such that a resulting response of the longitudinal optical sensor may be a ratio of the two longitudinal sensor signals. Thereby it may be possible to directly derive a distance from the response of the longitudinal optical sensor.

The detector may comprise at least two longitudinal optical sensors, wherein each longitudinal optical sensor may be adapted to generate at least one longitudinal sensor signal. As an example, the sensor regions or the sensor surfaces of the longitudinal optical sensors may, thus, be oriented in parallel, wherein slight angular tolerances might be tolerable, such as angular tolerances of no more than 10°, preferably of no more than 5°. Herein, preferably all of the longitudinal optical sensors of the detector, which may, preferably, be arranged in form of a stack along the optical axis of the detector, may be transparent. Thus, the light beam may pass through a first transparent longitudinal optical sensor before impinging on the other longitudinal optical sensors, preferably subsequently. Thus, the light beam from the object may subsequently reach all longitudinal optical sensors present in the optical detector. Herein, the different longitudinal optical sensors may exhibit the same or different spectral sensitivities with respect to the incident light beam.

The detector according to the present invention may comprise a stack of longitudinal optical sensors as disclosed in WO 2014/097181 A1, particularly in combination with one or more transversal optical sensors. As an example, one or more transversal optical sensors may be located on a side of the stack of longitudinal optical sensors facing towards the object. Alternatively or additionally, one or more transversal optical sensors may be located on a side of the stack of longitudinal optical sensors facing away from the object. Additionally or alternatively, one or more transversal optical sensors may be interposed in between the longitudinal optical sensors of the stack. However, embodiments which may only comprise a single longitudinal optical sensor but no transversal optical sensor may still be possible, such as in a case wherein only determining the depth of the object may be desired.

Preferably, the detector further may comprise at least one transversal optical sensor, the transversal optical sensor may be adapted to determine a transversal position of the light beam traveling from the object to the detector, the transversal position being a position in at least one dimension perpendicular to an optical axis of the detector, the transversal optical sensor may be adapted to generate at least one transversal sensor signal, wherein the evaluation device may further be designed to generate at least one item of information on a transversal position of the object by evaluating the transversal sensor signal.

As used herein, the term “transversal optical sensor” generally refers to a device which is adapted to determine a transversal position of at least one light beam traveling from the object to the detector. With regard to the term position, reference may be made to the definition above. Thus, preferably, the transversal position may be or may comprise at least one coordinate in at least one dimension perpendicular to an optical axis of the detector. As an example, the transversal position may be a position of a light spot generated by the light beam in a plane perpendicular to the optical axis, such as on a light-sensitive sensor surface of the transversal optical sensor. As an example, the position in the plane may be given in Cartesian coordinates and/or polar coordinates. Other embodiments are feasible. For potential embodiments of the transversal optical sensor, reference may be made to WO 2014/097181 A1. However, other embodiments are feasible and will be outlined in further detail below.

The transversal optical sensor may provide at least one transversal sensor signal. Herein, the transversal sensor signal may generally be an arbitrary signal indicative of the transversal position. As an example, the transversal sensor signal may be or may comprise a digital and/or an analog signal. As an example, the transversal sensor signal may be or may comprise a voltage signal and/or a current signal. Additionally or alternatively, the transversal sensor signal may be or may comprise digital data. The transversal sensor signal may comprise a single signal value and/or a series of signal values. The transversal sensor signal may further comprise an arbitrary signal which may be derived by combining two or more individual signals, such as by averaging two or more signals and/or by forming a quotient of two or more signals.

For example, similar to the disclosure according to WO 2014/097181 A1, the transversal optical sensor may be a photo detector having at least one first electrode, at least one second electrode and at least one photovoltaic material, wherein the photovoltaic material may be embedded in between the first electrode and the second electrode. Thus, the transversal optical sensor may be or may comprise one or more photo detectors, such as one or more organic photodetectors and, most preferably, one or more dye-sensitized organic solar cells (DSCs, also referred to as dye solar cells), such as one or more solid dye-sensitized organic solar cells (sDSCs). Thus, the detector may comprise one or more DSCs (such as one or more sDSCs) acting as the at least one transversal optical sensor and one or more DSCs (such as one or more sDSCs) acting as the at least one longitudinal optical sensor.

The transversal optical sensor may comprise the sensor area, which, preferably, may be transparent to the light beam travelling from the object to the detector. The transversal optical sensor may, therefore, be adapted to determine a transversal position of the light beam in one or more transversal directions, such as in the x- and/or in the y-direction. For this purpose, the at least one transversal optical sensor may further be adapted to generate at least one transversal sensor signal. Thus, the evaluation device may be designed to generate at least one item of information on a transversal position of the object by evaluating the transversal sensor signal of the longitudinal optical sensor. In addition to the at least one longitudinal coordinate of the object, at least one transversal coordinate of the object may be determined. Thus, generally, the evaluation device may further be adapted to determine at least one transversal coordinate of the object by determining a position of the light beam on the at least one transversal optical sensor, which may be a pixelated, a segmented or a large-area transversal optical sensor, as further outlined also in WO 2014/097181 A1.

In addition, the detector may further comprise one or more additional elements such as one or more additional optical elements. Further, the detector may fully or partially be integrated into at least one housing. The detector specifically may comprise at least one transfer element being adapted to guide the light beam onto the optical sensor. The transfer element may comprise one or more of: at least one lens, preferably at least one focus-tunable lens; at least one beam deflection element, preferably at least one mirror; at least one beam splitting element, preferably at least one of a beam splitting cube or a beam splitting mirror; at least one multi-lens system; diaphragms or the like. These optical elements which are adapted to modify the light beam, such as by modifying one or more of a beam parameter of the light beam, a width of the light beam or a direction of the light beam, above and in the following, are also referred to as a “transfer element”. Most preferably, the light beam which emerges from the object may in this case travel first through the at least one transfer element and thereafter through the single transparent longitudinal optical sensor or a stack of the transparent longitudinal optical sensors until it may finally impinge on an imaging device.

As outlined above, an unambiguous determination of at least one object may be possible by using a single longitudinal optical sensor. This simple configuration may enhance the available space behind the transfer device such that shorter focal lengths can be used compared to configurations using additional sensor devices. In addition, this configuration may allow flexibility in the optical setup, less spatial requirements and a reduction of expenses for optical elements and sensor.

In addition, the at least one transfer device may have imaging properties. Consequently, the transfer device comprises at least one imaging element, for example at least one lens and/or at least one curved mirror, since, in the case of such imaging elements, for example, a geometry of the illumination on the sensor region can be dependent on a relative positioning, for example a distance, between the transfer device and the object. As used herein, the transfer device may be designed in such a way that the electromagnetic radiation which emerges from the illumination source and/or from the object is transferred completely to the sensor region.

Generally, the detector may further comprise at least one imaging device, i.e. a device capable of acquiring at least one image. The imaging device can be embodied in various ways. Thus, the imaging device can be, for example, part of the detector in a detector housing. Alternatively or additionally, however, the imaging device can also be arranged outside the detector housing, for example as a separate imaging device. Alternatively or additionally, the imaging device can also be connected to the detector or even be part of the detector. In a preferred arrangement, the stack of the transparent longitudinal optical sensors and the imaging device are aligned along a common optical axis along which the light beam travels. Thus, it may be possible to locate an imaging device in the optical path of the light beam in a manner that the light beam travels through a single or a stack of the transparent longitudinal optical sensors until it impinges on the imaging device. However, other arrangements are possible.

As used herein, an “imaging device” is generally understood as a device which can generate a one-dimensional, a two-dimensional, or a three-dimensional image of the object or of a part thereof. In particular, the detector, with or without the at least one optional imaging device, can be completely or partly used as a camera, such as an IR camera, or an RGB camera, i.e. a camera which is designed to deliver three basic colors which are designated as red, green, and blue, on three separate connections. Thus, as an example, the at least one imaging device may be or may comprise at least one imaging device selected from the group consisting of: a pixelated organic camera element, preferably a pixelated organic camera chip; a pixelated inorganic camera element, preferably a pixelated inorganic camera chip, more preferably a CCD- or CMOS-chip; a monochrome camera element, preferably a monochrome camera chip; a multicolor camera element, preferably a multicolor camera chip; a full-color camera element, preferably a full-color camera chip. The imaging device may be or may comprise at least one device selected from the group consisting of a monochrome imaging device, a multi-chrome imaging device and at least one full color imaging device. A multi-chrome imaging device and/or a full color imaging device may be generated by using filter techniques and/or by using intrinsic color sensitivity or other techniques, as the skilled person will recognize. Other embodiments of the imaging device are also possible.

The imaging device may be designed to image a plurality of partial regions of the object successively and/or simultaneously. By way of example, a partial region of the object can be a one-dimensional, a two-dimensional, or a three-dimensional region of the object which is delimited, for example, by a resolution limit of the imaging device and from which electromagnetic radiation emerges. In this context, imaging should be understood to mean that the electromagnetic radiation which emerges from the respective partial region of the object is fed into the imaging device, for example by means of the at least one optional transfer device of the detector. The electromagnetic rays can be generated by the object itself, for example in the form of a luminescent radiation. Alternatively or additionally, the at least one detector may comprise at least one illumination source for illuminating the object.

In particular, the imaging device can be designed to image sequentially, for example by means of a scanning method, in particular using at least one row scan and/or line scan, the plurality of partial regions sequentially. However, other embodiments are also possible, for example embodiments in which a plurality of partial regions is simultaneously imaged. The imaging device is designed to generate, during this imaging of the partial regions of the object, signals, preferably electronic signals, associated with the partial regions. The signal may be an analogue and/or a digital signal. By way of example, an electronic signal can be associated with each partial region. The electronic signals can accordingly be generated simultaneously or else in a temporally staggered manner. By way of example, during a row scan or line scan, it is possible to generate a sequence of electronic signals which correspond to the partial regions of the object, which are strung together in a line, for example. Further, the imaging device may comprise one or more signal processing devices, such as one or more filters and/or analogue-digital-converters for processing and/or preprocessing the electronic signals.

In a further aspect of the present invention, a detector system for determining a position of at least one object is disclosed. The detector system comprises at least one detector according to the present invention, such as according to one or more of the embodiments disclosed above or according to one or more of the embodiments disclosed in further detail below. The detector system, further comprising at least one beacon device, is adapted to direct at least one light beam towards the detector, wherein the beacon device is at least one of attachable to the object, holdable by the object and integratable into the object.

Further details regarding the beacon device will be given below, including potential embodiments thereof. Thus, the at least one beacon device may be or may comprise at least one active beacon device, comprising one or more illumination sources, such as one or more light sources like lasers, LEDs, light bulbs or the like. Additionally or alternatively, the at least one beacon device may be adapted to reflect one or more light beams towards the detector, such as by comprising one or more reflective elements. Further, the at least one beacon device may be or may comprise one or more scattering elements adapted for scattering a light beam. Therein, elastic or inelastic scattering may be used. In case the at least one beacon device is adapted to reflect and/or scatter a primary light beam towards the detector, the beacon device may be adapted to leave the spectral properties of the light beam unaffected or, alternatively, may be adapted to change the spectral properties of the light beam, such as by modifying a wavelength of the light beam.

The light emerging from the beacon devices can alternatively or additionally, from the option that said light originates in the respective beacon device itself, emerge from the illumination source and/or be excited by the illumination source. By way of example, the electromagnetic light emerging from the beacon device can be emitted by the beacon device itself and/or be reflected by the beacon device and/or be scattered by the beacon device before it is fed to the detector. In this case, emission and/or scattering of the electromagnetic radiation can be effected without spectral influencing of the electromagnetic radiation or with such influencing. Thus, by way of example, a wavelength shift can also occur during scattering, for example according to Stokes or Raman. Furthermore, emission of light can be excited, for example, by a primary illumination source, for example, by the object or a partial region of the object being excited to generate luminescence, in particular phosphorescence and/or fluorescence. Other emission processes are also possible, in principle. If a reflection occurs, then the object can have, for example, at least one reflective region, in particular at least one reflective surface. Said reflective surface can be a part of the object itself, but can also be, for example, a reflector which is connected or spatially coupled to the object, for example, a reflector plaque connected to the object. If at least one reflector is used, then it can in turn also be regarded as part of the detector which is connected to the object, for example, independently of other constituent parts of the detector.

The beacon devices and/or the at least one optional illumination source generally may emit light in at least one of: the ultraviolet spectral range, preferably in the range of 200 nm to 380 nm; the visible spectral range (380 nm to 780 nm); the infrared spectral range, preferably in the range of 780 nm to 3.0 micrometers. For thermal imaging applications, the target may emit light in the far infrared spectral range, preferably in the range of 3.0 micrometers to 20 micrometers. Most preferably, the at least one illumination source is adapted to emit light in the visible spectral range, preferably in the range of 500 nm to 780 nm, most preferably at 650 nm to 750 nm or at 690 nm to 700 nm.

The detector system may comprise at least two beacon devices, wherein at least one property of a light beam emitted by a first beacon device may be different from at least one property of a light beam emitted by a second beacon device. The light beam of the first beacon device and the light beam of the second beacon device may be emitted simultaneously or sequentially. For example, the first beacon device may stay switched on and provide a first light beam, while the second beacon device may provide the second light beam.

Further, the present invention discloses a method for an optical detection of at least one object, in particular using a detector, such as a detector according to the present invention, such as according to one or more of the embodiments referring to a detector as disclosed above or as disclosed in further detail below. Still, other types of detectors may be used.

The method comprises the following method steps, wherein the method steps may be performed in the given order or may be performed in a different order. Further, one or more additional method steps may be present which are not listed. Further, one, more than one or even all of the method steps may be performed repeatedly.

The method steps are as follows:
Adjusting a beam cross-section of at least one first light beam and of at least one second light beam, wherein the first light beam has a first wavelength and the second light beam has a second wavelength different from the first wavelength, such that in the sensor region the beam cross-section of the first light beam is different from the beam cross-section of the second light beam;
generating at least one longitudinal sensor signal by using at least one longitudinal optical sensor, wherein the longitudinal sensor signal is dependent on an illumination of a sensor region of the longitudinal optical sensor by a light beam, wherein the longitudinal sensor signal, given the same total power of the illumination, is dependent on a beam cross-section of the light beam in the sensor region
evaluating the longitudinal sensor signal by using at least one evaluation device, wherein the longitudinal sensor signal of the longitudinal optical sensor is differentiated into a first longitudinal sensor signal dependent on the illumination of the sensor region by the first light beam and a second longitudinal sensor signal dependent on the illumination of the sensor region by the second light beam, and generating at least one item of information on a longitudinal position of the object by evaluating the first longitudinal sensor signal and the second longitudinal sensor signal.

For details, options and definitions, reference may be made to the detector as discussed above. Thus, specifically, as outlined above, the method may comprise using the detector according to the present invention, such as according to one or more of the embodiments given above or given in further detail below.

The method may further comprise modulating the first light beam and the second light beam.

The longitudinal optical sensor signal may be evaluated unambiguously. The first longitudinal sensor signal and the second longitudinal sensor signal may be evaluated simultaneously. Ambiguities may be resolved by considering at least two longitudinal sensor signals. Each longitudinal sensor signal may be dependent on the illumination of the sensor region of the longitudinal optical sensor by a light beam, wherein light intensity of the two light beams impinging on the sensor region is different. In particular, as outlined above the spot size of the first light beam and the second light beam on the sensor region is different. The method may furthermore comprise a comparison step, wherein the first longitudinal sensor signal and the second longitudinal sensor signal are compared. For example, in the comparison step, the longitudinal sensor signals may be normalized to generate the information on the longitudinal position of the object independent from an intensity of the light beam. For example, one of the first or second longitudinal sensor signals may be selected as a reference signal. By comparison of the selected reference signal and the other longitudinal signal, ambiguities may be eliminated. The longitudinal sensor signals may be compared, in order to gain information on the total power and/or intensity of the light beam and/or in order to normalize the longitudinal sensor signals and/or the at least one item of information on the longitudinal position of the object for the total power and/or total intensity of the light beam. For example, the longitudinal sensor signal may be normalized by division, thereby generating a normalized longitudinal optical sensor signal which, then, may be transformed by using the above-mentioned known relationship, into the at least one item of longitudinal information on the object. Thus, the transformation may be independent from the total power and/or intensity of the light beam. Thus, by division, ambiguities may be eliminated.

In a further aspect of the present invention, a human-machine interface for exchanging at least one item of information between a user and a machine is proposed. The human-machine interface as proposed may make use of the fact that the above-mentioned detector in one or more of the embodiments mentioned above or as mentioned in further detail below may be used by one or more users for providing information and/or commands to a machine. Thus, preferably, the human-machine interface may be used for inputting control commands.

The human-machine interface comprises at least one detector according to the present invention, such as according to one or more of the embodiments disclosed above and/or according to one or more of the embodiments as disclosed in further detail below, wherein the human-machine interface is designed to generate at least one item of geometrical information of the user by means of the detector wherein the human-machine interface is designed to assign the geometrical information to at least one item of information, in particular to at least one control command.

In a further aspect of the present invention, an entertainment device for carrying out at least one entertainment function is disclosed. As used herein, an entertainment device is a device which may serve the purpose of leisure and/or entertainment of one or more users, in the following also referred to as one or more players. As an example, the entertainment device may serve the purpose of gaming, preferably computer gaming. Additionally or alternatively, the entertainment device may also be used for other purposes, such as for exercising, sports, physical therapy or motion tracking in general. Thus, the entertainment device may be implemented into a computer, a computer network or a computer system or may comprise a computer, a computer network or a computer system which runs one or more gaming software programs.

The entertainment device comprises at least one human-machine interface according to the present invention, such as according to one or more of the embodiments disclosed above and/or according to one or more of the embodiments disclosed below. The entertainment device is designed to enable at least one item of information to be input by a player by means of the human-machine interface. The at least one item of information may be transmitted to and/or may be used by a controller and/or a computer of the entertainment device.

In a further aspect of the present invention, a tracking system for tracking the position of at least one movable object is provided. As used herein, a tracking system is a device which is adapted to gather information on a series of past positions of the at least one object or at least one part of an object. Additionally, the tracking system may be adapted to provide information on at least one predicted future position of the at least one object or the at least one part of the object. The tracking system may have at least one track controller, which may fully or partially be embodied as an electronic device, preferably as at least one data processing device, more preferably as at least one computer or microcontroller. Again, the at least one track controller may comprise the at least one evaluation device and/or may be part of the at least one evaluation device and/or might fully or partially be identical to the at least one evaluation device.

The tracking system comprises at least one detector according to the present invention, such as at least one detector as disclosed in one or more of the embodiments listed above and/or as disclosed in one or more of the embodiments below. As outlined above, an unambiguous determination of at least one object may be possible by using a single longitudinal optical sensor. Thus, a simple and cost effective configuration of an x-y-z tracking system is possible. The tracking system further comprises at least one track controller. The tracking system may comprise one, two or more detectors, particularly two or more identical detectors, which allow for a reliable acquisition of depth information about the at least one object in an overlapping volume between the two or more detectors. The track controller is adapted to track a series of positions of the object, each position comprising at least one item of information on a position of the object at a specific point in time, such as by recording groups of data or data pairs, each group of data or data pair comprising at least one position information and at least one time information.

The tracking system may further comprise the at least one detector system according to the present invention. Thus, besides the at least one detector and the at least one evaluation device and the optional at least one beacon device, the tracking system may further comprise the object itself or a part of the object, such as at least one control element comprising the beacon devices or at least one beacon device, wherein the control element is directly or indirectly attachable to or integratable into the object to be tracked.

The tracking system may be adapted to initiate one or more actions of the tracking system itself and/or of one or more separate devices. For the latter purpose, the tracking system, preferably the track controller, may have one or more wireless and/or wire-bound interfaces and/or other types of control connections for initiating at least one action. Preferably, the at least one track controller may be adapted to initiate at least one action in accordance with at least one actual position of the object. As an example, the action may be selected from the group consisting of: a prediction of a future position of the object; pointing at least one device towards the object; pointing at least one device towards the detector; illuminating the object; illuminating the detector.

As an example of application of a tracking system, the tracking system may be used for continuously pointing at least one first object to at least one second object even though the first object and/or the second object might move. Potential examples, again, may be found in industrial applications, such as in robotics and/or for continuously working on an article even though the article is moving, such as during manufacturing in a manufacturing line or assembly line. Additionally or alternatively, the tracking system might be used for illumination purposes, such as for continuously illuminating the object by continuously pointing an illumination source to the object even though the object might be moving. Further applications might be found in communication systems, such as in order to continuously transmit information to a moving object by pointing a transmitter towards the moving object.

The tracking system may further comprise at least one beacon device connectable to the object. For a potential definition of the beacon device, reference may be made to WO 2014/097181 A1.

The tracking system preferably is adapted such that the detector may generate an information on the position of the object of the at least one beacon device, in particular to generate the information on the position of the object which comprises a specific beacon device exhibiting a specific spectral sensitivity. Thus, more than one beacon exhibiting a different spectral sensitivity may be tracked by the detector of the present invention, preferably in a simultaneous manner.

Herein, the beacon device may fully or partially be embodied as an active beacon device and/or as a passive beacon device. As an example, the beacon device may comprise at least one illumination source adapted to generate at least one light beam to be transmitted to the detector. Additionally or alternatively, the beacon device may comprise at least one reflector adapted to reflect light generated by an illumination source, thereby generating a reflected light beam to be transmitted to the detector.

In a further aspect of the present invention, a scanning system for determining at least one position of at least one object is provided. As used herein, the scanning system is a device which is adapted to emit at least one light beam being configured for an illumination of at least one dot located at at least one surface of the at least one object and for generating at least one item of information about the distance between the at least one dot and the scanning system. For the purpose of generating the at least one item of information about the distance between the at least one dot and the scanning system, the scanning system comprises at least one of the detectors according to the present invention, such as at least one of the detectors as disclosed in one or more of the embodiments listed above and/or as disclosed in one or more of the embodiments below.

Thus, the scanning system comprises at least one illumination source which is adapted to emit the at least one light beam being configured for the illumination of the at least one dot located at the at least one surface of the at least one object. The illumination source may be designed as the illumination source described above in the context of the detector for an optical detection of at least one object. As used herein, the term “dot” refers to a small area on a part of the surface of the object which may be selected, for example by a user of the scanning system, to be illuminated by the illumination source. Preferably, the dot may exhibit a size which may, on one hand, be as small as possible in order to allow the scanning system determining a value for the distance between the illumination source comprised by the scanning system and the part of the surface of the object on which the dot may be located as exactly as possible and which, on the other hand, may be as large as possible in order to allow the user of the scanning system or the scanning system itself, in particular by an automatic procedure, to detect a presence of the dot on the related part of the surface of the object.

For this purpose, the illumination source may comprise an artificial illumination source, in particular at least one laser source and/or at least one incandescent lamp and/or at least one semiconductor light source, for example, at least one light-emitting diode, in particular an organic and/or inorganic light-emitting diode. On account of their generally defined beam profiles and other properties of handleability, the use of at least one laser source as the illumination source is particularly preferred. Herein, the use of a single laser source may be preferred, in particular in a case in which it may be important to provide a compact scanning system that might be easily storable and transportable by the user. Preferably, the illumination source may comprise a single laser source adapted to generate light beams having different wavelengths. The illumination source may thus, preferably be a constituent part of the detector and may, therefore, in particular be integrated into the detector, such as into the housing of the detector. In a preferred embodiment, particularly the housing of the scanning system may comprise at least one display configured for providing distance-related information to the user, such as in an easy-to-read manner. In a further preferred embodiment, particularly the housing of the scanning system may, in addition, comprise at least one button which may be configured for operating at least one function related to the scanning system, such as for setting one or more operation modes. In a further preferred embodiment, particularly the housing of the scanning system may, in addition, comprise at least one fastening unit which may be configured for fastening the scanning system to a further surface, such as a rubber foot, a base plate or a wall holder, such comprising as magnetic material, in particular for increasing the accuracy of the distance measurement and/or the handleability of the scanning system by the user.

In a particularly preferred embodiment, the illumination source of the scanning system may, thus, emit a single laser beam which may be configured for the illumination of a single dot located at the surface of the object. By using at least one of the detectors according to the present invention at least one item of information about the distance between the at least one dot and the scanning system may, thus, be generated. Hereby, preferably, the distance between the illumination system as comprised by the scanning system and the single dot as generated by the illumination source may be determined, such as by employing the evaluation device as comprised by the at least one detector. However, the scanning system may, further, comprise an additional evaluation system which may, particularly, be adapted for this purpose. Alternatively or in addition, a size of the scanning system, in particular of the housing of the scanning system, may be taken into account and, thus, the distance between a specific point on the housing of the scanning system, such as a front edge or a back edge of the housing, and the single dot may, alternatively, be determined.

Alternatively, in order to provide at least two light beams with different wavelengths, the illumination source may comprise two laser sources emitting light in different wavelengths. The illumination source may emit at least two laser beams. Each of the laser beams may be configured for the illumination of a single dot located on the surface of the object. Furthermore, the illumination source of the scanning system may emit two individual laser beams which may be configured for providing a respective angle, such as a right angle, between the directions of an emission of the beams, whereby two respective dots located at the surface of the same object or at two different surfaces at two separate objects may be illuminated. However, other values for the respective angle between the two individual laser beams may also be feasible. This feature may, in particular, be employed for indirect measuring functions, such as for deriving an indirect distance which may not be directly accessible, such as due to a presence of one or more obstacles between the scanning system and the dot or which may otherwise be hard to reach. By way of example, it may, thus, be feasible to determine a value for a height of an object by measuring two individual distances and deriving the height by using the Pythagoras formula. In particular for being able to keep a predefined level with respect to the object, the scanning system may, further, comprise at least one leveling unit, in particular an integrated bubble vial, which may be used for keeping the predefined level by the user.

As a further alternative, the illumination source of the scanning system may emit a plurality of individual laser beams, such as an array of laser beams which may exhibit a respective pitch, in particular a regular pitch, with respect to each other and which may be arranged in a manner in order to generate an array of dots located on the at least one surface of the at least one object. For this purpose, specially adapted optical elements, such as beam-splitting devices and mirrors, may be provided which may allow a generation of the described array of the laser beams.

Thus, the scanning system may provide a static arrangement of the one or more dots placed on the one or more surfaces of the one or more objects. Alternatively, illumination source of the scanning system, in particular the one or more laser beams, such as the above described array of the laser beams, may be configured for providing one or more light beams which may exhibit a varying intensity over time and/or which may be subject to an alternating direction of emission in a passage of time. Thus, the illumination source may be configured for scanning a part of the at least one surface of the at least one object as an image by using one or more light beams with alternating features as generated by the at least one illumination source of the scanning device. In particular, the scanning system may, thus, use at least one row scan and/or line scan, such as to scan the one or more surfaces of the one or more objects sequentially or simultaneously. As non-limiting examples, the scanning system may be used in safety laser scanners, e.g. in production environments, and/or in 3D-scanning devices as used for determining the shape of an object, such as in connection to 3D-printing, body scanning, quality control, in construction applications, e.g. as range meters, in logistics applications, e.g. for determining the size or volume of a parcel, in household applications, e.g. in robotic vacuum cleaners or lawn mowers, or in other kinds of applications which may include a scanning step.

In a further aspect of the present invention, a camera for imaging at least one object is disclosed. The camera comprises at least one detector according to the present invention, such as disclosed in one or more of the embodiments given above or given in further detail below. Thus, the detector may be part of a photographic device, specifically of a digital camera. Specifically, the detector may be used for 3D photography, specifically for digital 3D photography. Thus, the detector may form a digital 3D camera or may be part of a digital 3D camera. As used herein, the term “photography” generally refers to the technology of acquiring image information of at least one object. As further used herein, a “camera” generally is a device adapted for performing photography. As further used herein, the term “digital photography” generally refers to the technology of acquiring image information of at least one object by using a plurality of light-sensitive elements adapted to generate electrical signals indicating an intensity of illumination, preferably digital electrical signals. As further used herein, the term “3D photography” generally refers to the technology of acquiring image information of at least one object in three spatial dimensions. Accordingly, a 3D camera is a device adapted for performing 3D photography. The camera generally may be adapted for acquiring a single image, such as a single 3D image, or may be adapted for acquiring a plurality of images, such as a sequence of images. Thus, the camera may also be a video camera adapted for video applications, such as for acquiring digital video sequences.

Thus, generally, the present invention further refers to a camera, specifically a digital camera, more specifically a 3D camera or digital 3D camera, for imaging at least one object. As outlined above, the term imaging, as used herein, generally refers to acquiring image information of at least one object. The camera comprises at least one detector according to the present invention. The camera, as outlined above, may be adapted for acquiring a single image or for acquiring a plurality of images, such as image sequence, preferably for acquiring digital video sequences. Thus, as an example, the camera may be or may comprise a video camera. In the latter case, the camera preferably comprises a data memory for storing the image sequence.

In a further aspect of the present invention, a use of the optical detector according to the present invention, such as disclosed in one or more of the embodiments discussed above and/or as disclosed in one or more of the embodiments given in further detail below, is disclosed, for a purpose of use, selected from the group consisting of: a position measurement in traffic technology; an entertainment application; a security application; a human-machine interface application; a tracking application; a scanning application; a photography application; a mapping application for generating maps of at least one space, such as at least one space selected from the group of a room, a building and a street; a mobile application; a webcam; an audio device; a dolby surround audio system; a computer peripheral device; a gaming application; an audio application; a camera or video application; a security application; a surveillance application; an automotive application; a transport application; a medical application; an agricultural application;

an application connected to breeding plants or animals; a crop protection application; a sports application; a machine vision application; a vehicle application; an airplane application; a ship application; a spacecraft application; a building application; a construction application; a cartography application; a manufacturing application; a robotics application; a quality control application; a manufacturing application; a use in combination with a stereo camera; a quality control application; a use in combination with at least one time-of-flight detector; a use in combination with a structured illumination source; a use in combination with a stereo camera; a use in an active target distance measurement setup. Additionally or alternatively, applications in local and/or global positioning systems may be named, especially landmark-based positioning and/or indoor and/or outdoor navigation, specifically for use in cars or other vehicles (such as trains, motorcycles, bicycles, trucks for cargo transportation), robots or for use by pedestrians. Further, indoor positioning systems may be named as potential applications, such as for household applications and/or for robots used in manufacturing technology.

Further, the optical detector according to the present invention may be used in automatic door openers, such as in so-called smart sliding doors, such as a smart sliding door disclosed in Jie-Ci Yang et al., Sensors 2013, 13(5), 5923-5936; doi:10.3390/s130505923. At least one optical detector according to the present invention may be used for detecting when a person or an object approaches the door, and the door may automatically open.

Further applications, as outlined above, may be global positioning systems, local positioning systems, indoor navigation systems or the like. Thus, the devices according to the present invention, i.e. one or more of the optical detector, the detector system, the human-machine interface, the entertainment device, the tracking system or the camera, specifically may be part of a local or global positioning system. Additionally or alternatively, the devices may be part of a visible light communication system. Other uses are feasible.

The devices according to the present invention, i.e. one or more of the optical detector, the detector system, the human-machine interface, the entertainment device, the tracking system, the scanning system, or the camera, further specifically may be used in combination with a local or global positioning system, such as for indoor or outdoor navigation. As an example, one or more devices according to the present invention may be combined with software/database-combinations such as Google Maps® or Google Street View®. Devices according to the present invention may further be used to analyze the distance to objects in the surrounding, the position of which can be found in the database. From the distance to the position of the known object, the local or global position of the user may be calculated.

Thus, the optical detector, the detector system, the human-machine interface, the entertainment device, the tracking system, the scanning system, or the camera according to the present invention (in the following simply referred to as “the devices according to the present invention” or—without restricting the present invention to the potential use of the FiP effect—“FiP-devices”) may be used for a plurality of application purposes, such as one or more of the purposes disclosed in further detail in the following.

Thus, firstly, the devices according to the present invention, also denominated as “FiP-devices” may be used in mobile phones, tablet computers, laptops, smart panels or other stationary or mobile computer or communication applications. Thus, the devices according to the present invention may be combined with at least one active light source, such as a light source emitting light in the visible range or infrared spectral range, in order to enhance performance. Thus, as an example, the devices according to the present invention may be used as cameras and/or sensors, such as in combination with mobile software for scanning environment, objects and living beings. The devices according to the present invention may even be combined with 2D cameras, such as conventional cameras, in order to increase imaging effects. The devices according to the present invention may further be used for surveillance and/or for recording purposes or as input devices to control mobile devices, especially in combination with gesture recognition. Thus, specifically, the devices according to the present invention acting as human-machine interfaces, also referred to as FiP input devices, may be used in mobile applications, such as for controlling other electronic devices or components via the mobile device, such as the mobile phone. As an example, the mobile application including at least one FiP-device may be used for controlling a television set, a game console, a music player or music device or other entertainment devices.

Further, the devices according to the present invention may be used in webcams or other peripheral devices for computing applications. Thus, as an example, the devices according to the present invention may be used in combination with software for imaging, recording, surveillance, scanning, or motion detection. As outlined in the context of the human-machine interface and/or the entertainment device, the devices according to the present invention are particularly useful for giving commands by facial expressions and/or body expressions. The devices according to the present invention can be combined with other input generating devices like e.g. mouse, keyboard, touchpad, etc. Further, the devices according to the present invention may be used in applications for gaming, such as by using a webcam. Further, the devices according to the present invention may be used in virtual training applications and/or video conferences. Further, the devices according to the present invention may be used to recognize or track hands, arms, or objects used in a virtual or augmented reality application, especially when wearing head mounted displays.

Further, the devices according to the present invention may be used in mobile audio devices, television devices and gaming devices, as partially explained above. Specifically, the devices according to the present invention may be used as controls or control devices for electronic devices, entertainment devices or the like. Further, the devices according to the present invention may be used for eye detection or eye tracking, such as in 2D- and 3D-display techniques, especially with transparent displays for augmented reality applications and/or for recognizing whether a display is being looked at and/or from which perspective a display is being looked at. Further, the devices according to the present invention may be used to explore a room, boundaries, obstacles, in connection with a virtual or augmented reality application, especially when wearing a head-mounted display.

Further, the devices according to the present invention may be used in or as digital cameras such as DSC cameras and/or in or as reflex cameras such as SLR cameras. For these applications, reference may be made to the use of the devices according to the present invention in mobile applications such as mobile phones, as disclosed above.

Further, the devices according to the present invention may be used for security and surveillance applications. Thus, as an example, FiP-sensors in general can be combined with one or more digital and/or analog electronics that will give a signal if an object is within or outside a predetermined area (e.g. for surveillance applications in banks or museums). Specifically, the devices according to the present invention may be used for optical encryption. FiP-based detection can be combined with other detection devices to complement wavelengths, such as with IR, x-ray, UV-VIS, radar or ultrasound detectors. The devices according to the present invention may further be combined with an active infrared light source to allow detection in low light surroundings. The devices according to the present invention such as FIP-based sensors are generally advantageous as compared to active detector systems, specifically since the devices according to the present invention avoid actively sending signals which may be detected by third parties, as is the case e.g. in radar applications, ultrasound applications, LI DAR or similar active detector device is. Thus, generally, the devices according to the present invention may be used for an unrecognized and undetectable tracking and/or scanning of moving objects. Additionally, the devices according to the present invention generally are less prone to manipulations and irritations as compared to conventional devices.

Further, given the ease and accuracy of 3D detection by using the devices according to the present invention, the devices according to the present invention generally may be used for facial, body and person recognition and identification. Therein, the devices according to the present invention may be combined with other detection means for identification or personalization purposes such as passwords, finger prints, iris detection, voice recognition or other means. Thus, generally, the devices according to the present invention may be used in security devices and other personalized applications.

Further, the devices according to the present invention may be used as 3D-barcode readers for product identification.

In addition to the security and surveillance applications mentioned above, the devices according to the present invention generally can be used for surveillance and monitoring of spaces and areas. Thus, the devices according to the present invention may be used for surveying and monitoring spaces and areas and, as an example, for triggering or executing alarms in case prohibited areas are violated. Thus, generally, the devices according to the present invention may be used for surveillance purposes in building surveillance or museums, optionally in combination with other types of sensors, such as in combination with motion or heat sensors, in combination with image intensifiers or image enhancement devices and/or photomultipliers. Further, the devices according to the present invention may be used in public spaces or crowded spaces to detect potentially hazardous activities such as commitment of crimes such as theft in a parking lot or unattended objects such as unattended baggage in an airport.

Further, the devices according to the present invention may advantageously be applied in camera applications such as video and camcorder applications. Thus, the devices according to the present invention may be used for motion capture and 3D-movie recording. Therein, the devices according to the present invention generally provide a large number of advantages over conventional optical devices. Thus, the devices according to the present invention generally require a lower complexity with regard to optical components. Thus, as an example, the number of lenses may be reduced as compared to conventional optical devices, such as by providing the devices according to the present invention having one lens only. Due to the reduced complexity, very compact devices are possible, such as for mobile use. Conventional optical systems having two or more lenses with high quality generally are voluminous, such as due to the general need for voluminous beam-splitters. Further, the devices according to the present invention generally may be used for focus/autofocus devices, such as autofocus cameras. Further, the devices according to the present invention may also be used in optical microscopy, especially in confocal microscopy.

Further, the devices according to the present invention are applicable in the technical field of automotive technology and transport technology. Thus, as an example, the devices according to the present invention may be used as distance and surveillance sensors, such as for adaptive cruise control, emergency brake assist, lane departure warning, surround view, blind spot detection, rear cross traffic alert, and other automotive and traffic applications. Further, FiP-sensors can also be used for velocity and/or acceleration measurements, such as by analyzing a first and second time-derivative of position information gained by using the FiP-sensor. This feature generally may be applicable in automotive technology, transportation technology or general traffic technology. Applications in other fields of technology are feasible. A specific application in an indoor positioning system may be the detection of positioning of passengers in transportation, more specifically to electronically control the use of safety systems such as airbags. The use of an airbag may be prevented in case the passenger is located as such, that the use of an airbag will cause a severe injury.

In these or other applications, generally, the devices according to the present invention may be used as standalone devices or in combination with other sensor devices, such as in combination with radar and/or ultrasonic devices. Specifically, the devices according to the present invention may be used for autonomous driving and safety issues. Further, in these applications, the devices according to the present invention may be used in combination with infrared sensors, radar sensors, which are sonic sensors, two-dimensional cameras or other types of sensors. In these applications, the generally passive nature of typical the devices according to the present invention is advantageous. Thus, since the devices according to the present invention generally do not require emitting signals, the risk of interference of active sensor signals with other signal sources may be avoided. The devices according to the present invention specifically may be used in combination with recognition software, such as standard image recognition software. Thus, signals and data as provide by the devices according to the present invention typically are readily processable and, therefore, generally require lower calculation power than established stereovision systems such as LI DAR. Given the low space demand, the devices according to the present invention such as cameras using the FiP-effect may be placed at virtually any place in a vehicle, such as on a window screen, on a front hood, on bumpers, on lights, on mirrors or other places the like. Various detectors based on the FiP-effect can be combined, such as in order to allow autonomously driving vehicles or in order to increase the performance of active safety concepts. Thus, various FiP-based sensors may be combined with other FiP-based sensors and/or conventional sensors, such as in the windows like rear window, side window or front window, on the bumpers or on the lights.

A combination of at least one device according to the present invention, such as at least one detector according to the present invention, with one or more rain detection sensors is also possible. This is due to the fact that the devices according to the present invention generally are advantageous over conventional sensor techniques such as radar, specifically during heavy rain. A combination of at least one FiP-device with at least one conventional sensing technique such as radar may allow for a software to pick the right combination of signals according to the weather conditions.

Further, the devices according to the present invention generally may be used as break assist and/or parking assist and/or for speed measurements. Speed measurements can be integrated in the vehicle or may be used outside the vehicle, such as in order to measure the speed of other cars in traffic control. Further, the devices according to the present invention may be used for detecting free parking spaces in parking lots.

Further, the devices according to the present invention may be used is the fields of medical systems and sports. Thus, in the field of medical technology, surgery robotics, e.g. for use in endoscopes, may be named, since, as outlined above, the devices according to the present invention may require a low volume only and may be integrated into other devices. Specifically, the devices according to the present invention having one lens, at most, may be used for capturing 3D information in medical devices such as in endoscopes. Further, the devices according to the present invention may be combined with an appropriate monitoring software, in order to enable tracking and/or scanning and analysis of movements. This may allow an instant overlay of the position of a medical device, such as an endoscope or a scalpel, with results from medical imaging, such as obtained from magnetic resonance imaging, x-ray imaging, or ultrasound imaging. These applications are specifically valuable e.g. in medical treatments and long-distance diagnosis and tele-medicine. Further, the devices according to the present invention may be used in 3D-body scanning. Body scanning may be applied in a medical context, such as in dental surgery, plastic surgery, bariatric surgery, or cosmetic plastic surgery, or it may be applied in the context of medical diagnosis such as in the diagnosis of myofascial pain syndrome, cancer, body dysmorphic disorder, or further diseases. Body scanning may further be applied in the field of sports to assess ergonomic use or fit of sports equipment.

Body scanning may further be used in the context of clothing, such as to determine a suitable size and fitting of clothes. This technology may be used in the context of tailor-made clothes or in the context of ordering clothes or shoes from the internet or at a self-service shopping device such as a micro kiosk device or customer concierge device. Body scanning in the context of clothing is especially important for scanning fully dressed customers.

Further, the devices according to the present invention may be used in the context of people counting systems, such as to count the number of people in an elevator, a train, a bus, a car, or a plane, or to count the number of people passing a hallway, a door, an aisle, a retail store, a stadium, an entertainment venue, a museum, a library, a public location, a cinema, a theater, or the like. Further, the 3D-function in the people counting system may be used to obtain or estimate further information about the people that are counted such as height, weight, age, physical fitness, or the like. This information may be used for business intelligence metrics, and/or for further optimizing the locality where people may be counted to make it more attractive or safe. In a retail environment, the devices according to the present invention in the context of people counting may be used to recognize returning customers or cross shoppers, to assess shopping behavior, to assess the percentage of visitors that make purchases, to optimize staff shifts, or to monitor the costs of a shopping mall per visitor. Further, people counting systems may be used to assess customer pathways through a supermarket, shopping mall, or the like. Further, people counting systems may be used for anthropometric surveys. Further, the devices according to the present invention may be used in public transportation systems for automatically charging passengers depending on the length of transport. Further, the devices according to the present invention may be used in playgrounds for children, to recognize injured children or children engaged in dangerous activities, to allow additional interaction with playground toys, to ensure safe use of playground toys or the like.

Further the devices according to the present invention may be used in construction tools, such as a range meter that determines the distance to an object or to a wall, to assess whether a surface is planar, to align or objects or place objects in an ordered manner, or in inspection cameras for use in construction environments or the like.

Further, the devices according to the present invention may be applied in the field of sports and exercising, such as for training, remote instructions or competition purposes. Specifically, the devices according to the present invention may be applied in the field of dancing, aerobic, football, soccer, basketball, baseball, cricket, hockey, track and field, swimming, polo, handball, volleyball, rugby, sumo, judo, fencing, boxing etc. The devices according to the present invention can be used to detect the position of a ball, a bat, a sword, motions, etc., both in sports and in games, such as to monitor the game, support the referee or for judgment, specifically automatic judgment, of specific situations in sports, such as for judging whether a point or a goal actually was made.

The devices according to the present invention may further be used to support a practice of musical instruments, in particular remote lessons, for example lessons of string instruments, such as fiddles, violins, violas, celli, basses, harps, guitars, banjos, or ukuleles, keyboard instruments, such as pianos, organs, keyboards, harpsichords, harmoniums, or accordions, and/or percussion instruments, such as drums, timpani, marimbas, xylophones, vibraphones, bongos, congas, timbales, djembes or tablas.

The devices according to the present invention further may be used in rehabilitation and physiotherapy, in order to encourage training and/or in order to survey and correct movements. Therein, the devices according to the present invention may also be applied for distance diagnostics.

Further, the devices according to the present invention may be applied in the field of machine vision. Thus, one or more the devices according to the present invention may be used e.g. as a passive controlling unit for autonomous driving and or working of robots. In combination with moving robots, the devices according to the present invention may allow for autonomous movement and/or autonomous detection of failures in parts. The devices according to the present invention may also be used for manufacturing and safety surveillance, such as in order to avoid accidents including but not limited to collisions between robots, production parts and living beings. In robotics, the safe and direct interaction of humans and robots is often an issue, as robots may severely injure humans when they are not recognized. Devices according to the present invention may help robots to position objects and humans better and faster and allow a safe interaction. Given the passive nature of the devices according to the present invention, the devices according to the present invention may be advantageous over active devices and/or may be used complementary to existing solutions like radar, ultrasound, 2D cameras, IR detection etc. One particular advantage of the devices according to the present invention is the low likelihood of signal interference. Therefore multiple sensors can work at the same time in the same environment, without the risk of signal interference. Thus, the devices according to the present invention generally may be useful in highly automated production environments like e.g. but not limited to automotive, mining, steel, etc. The devices according to the present invention can also be used for quality control in production, e.g. in combination with other sensors like 2-D imaging, radar, ultrasound, IR etc., such as for quality control or other purposes. Further, the devices according to the present invention may be used for assessment of surface quality, such as for surveying the surface evenness of a product or the adherence to specified dimensions, from the range of micrometers to the range of meters. Other quality control applications are feasible. In a manufacturing environment, the devices according to the present invention are especially useful for processing natural products such as food or wood, with a complex 3-dimensional structure to avoid large amounts of waste material. Further, devices according to the present invention may be used to monitor the filling level of tanks, silos etc. Further, devices according to the present invention may be used to inspect complex products for missing parts, incomplete parts, loose parts, low quality parts, or the like, such as in automatic optical inspection, such as of printed circuit boards, inspection of assemblies or sub-assemblies, verification of engineered components, engine part inspections, wood quality inspection, label inspections, inspection of medical devices, inspection of product orientations, packaging inspections, food pack inspections, or the like.

In particular, the devices according to the present invention may be used in industrial quality control for identifying a property related to a manufacturing, packaging and distribution of products, in particular products which comprise a non-solid phase, particularly a fluid, such as a liquid, an emulsion, a gas, an aerosol, or a mixture thereof. These kinds products, which may, generally, be present in the chemistry, pharmaceutical, cosmetics, food and beverage industry as well as in other industrial areas, usually require a solid receptacle, which may be denoted as container, case, or bottle, wherein the receptacle may, preferably, be full or at least partially transparent. For sake of simplicity, in the following the term “bottle” may be used as a particular frequent example without intending any actual restriction, such as to the shape or the material of the receptacle. Consequently, the bottle which comprises the corresponding product may be characterized by a number of optical parameters which may be used for quality control, preferably by employing the optical detector or a system comprising the optical detector according to the present invention. Within this regard, the optical detector may, especially, be used for detecting one or more of the following optical parameters, which may comprise a filling level of the product within the bottle, a shape of the bottle, and a property of a label which may be attached to the bottle, in particular for comprising respective product information.

According to the state of the art, industrial quality control of this kind may usually be performed by using industrial cameras and subsequent image analysis in order to assess one or more of the mentioned optical parameters by recording and evaluating the respective image, whereby, since the answer as usually required by industrial quality control is a logic statement which may only attain the values TRUE (i.e. quality sufficient) or FALSE (i.e. quality insufficient), most of the acquired complex information with regard to the optical parameters may, in general, be discarded. By way of example, industrial cameras may be required for recording an image of a bottle, wherein the image may be assessed in the subsequent image analysis in order to detect a filling label, any possible deformation of the shape of the bottle and any errors and/or omissions comprised on the corresponding label as attached onto the bottle. In particular, since the deviations are usually rather small, different recorded images of the same product are all highly similar. Consequently, an image analysis which may employ simple tools, such as color levels or greyscales, is, generally, not sufficient. Further, conventional large-area image sensors yield little information, in particular due to their linear independence from the power of an incident light beam.

In contrast to this, the optical detector according to the present invention already comprises a setup with one or more optical sensors which exhibit a known dependency from the power of the incident light beam, which may, especially, result in a larger influence onto an image of the product with respect to the above mentioned optical parameters, such as the filling level of the product within the bottle, the shape of the bottle, and the at least one property of the label attached to the bottle. In particular, the optical sensors may, therefore, be adapted to directly condense complex information as comprised within the image of the product into one or more sensor signals, such as easily accessible current signals, thus avoiding the existing necessity of performing a sophisticated image analysis. Moreover, as already described above, the object of the present invention, which particularly refers to providing an autofocus device, wherein the sensor signal, such as a local maximum or minimum in the sensor current within a respective time interval, may indicate that the product under investigation is actually in focus, may further support the evaluation of the above mentioned optical parameters from the image of the corresponding product. Even in case an autofocus device may be used in cameras known from the state of the art, a lens system may, generally, only cover a limited range of distances, since the focus usually remains unchanged during the measurement. The measurement concept according to the present invention which is based on the use of a focus-tunable lens, however, may cover a much broader range, since varying the focus over a large range may be possible by employing the measurement concept as described herein. Furthermore, a use of specifically adapted transfer devices, illumination sources, such as devices configured for providing symmetry breaking and/or modulated illumination, modulation devices and/or sensor stacks may further enhance the reliability of the acquired information during the quality control.

Further, the devices according to the present invention may be used in the polls, vehicles, trains, airplanes, ships, spacecraft and other traffic applications. Thus, besides the applications mentioned above in the context of traffic applications, passive tracking systems for aircrafts, vehicles and the like may be named. The use of at least one device according to the present invention, such as at least one detector according to the present invention, for monitoring the speed and/or the direction of moving objects is feasible. Specifically, the tracking of fast moving objects on land, sea and in the air including space may be named. The at least one FiP-detector specifically may be mounted on a still-standing and/or on a moving device. An output signal of the at least one FiP-device can be combined e.g. with a guiding mechanism for autonomous or guided movement of another object. Thus, applications for avoiding collisions or for enabling collisions between the tracked and the steered object are feasible. The devices according to the present invention generally are useful and advantageous due to the low calculation power required, the instant response and due to the passive nature of the detection system which generally is more difficult to detect and to disturb as compared to active systems, like e.g. radar. Further, the devices according to the present invention may be used to assist airplanes during landing or take-off procedure, especially in close proximity to the runway, where radar systems might not work accurately enough. Such landing or take-off assistance devices may be realized by beacon devices fixed to the ground such as the runway or fixed to the aircraft, or by an illumination and measurement devices fixed to either the aircraft or the ground, or both. The devices according to the present invention are particularly useful but not limited to e.g. speed control and air traffic control devices. Further, the devices according to the present invention may be used in automated tolling systems for road charges.

The devices according to the present invention generally may be used in passive applications. Passive applications include guidance for ships in harbors or in dangerous areas, and for aircrafts at landing or starting, wherein, fixed, known active targets may be used for precise guidance. The same can be used for vehicles driving in dangerous but well defined routes, such as mining vehicles. Further, the devices according to the present invention may be used to detect rapidly approaching objects, such as cars, trains, flying objects, animals, or the like. Further, the devices according to the present invention can be used for detecting velocities or accelerations of objects, or to predict the movement of an object by tracking one or more of its position, speed, and/or acceleration depending on time.

Further, as outlined above, the devices according to the present invention may be used in the field of gaming. Thus, the devices according to the present invention can be passive for use with multiple objects of the same or of different size, color, shape, etc., such as for movement detection in combination with software that incorporates the movement into its content. In particular, applications are feasible in implementing movements into graphical output. Further, applications of the devices according to the present invention for giving commands are feasible, such as by using one or more the devices according to the present invention for gesture or facial recognition. The devices according to the present invention may be combined with an active system in order to work under e.g. low light conditions or in other situations in which enhancement of the surrounding conditions is required. Additionally or alternatively, a combination of one or more of the devices according to the present invention with one or more IR or VIS light sources is possible, such as with a detection device based on the FiP effect. A combination of a FiP-based detector with special devices is also possible, which can be distinguished easily by the system and its software, e.g. and not limited to, a special color, shape, relative position to other devices, speed of movement, light, frequency used to modulate light sources on the device, surface properties, material used, reflection properties, transparency degree, absorption characteristics, etc. The device can, amongst other possibilities, resemble a stick, a racquet, a club, a gun, a knife, a wheel, a ring, a steering wheel, a bottle, a ball, a glass, a vase, a spoon, a fork, a cube, a dice, a figure, a puppet, a teddy, a beaker, a pedal, a switch, a glove, jewelry, a musical instrument or an auxiliary device for playing a musical instrument, such as a plectrum, a drumstick or the like. Other options are feasible.

Further, the devices according to the present invention may be used to detect and or track objects that emit light by themselves, such as due to high temperature or further light emission processes. The light emitting part may be an exhaust stream or the like. Further, the devices according to the present invention may be used to track reflecting objects and analyze the rotation or orientation of these objects.

Further, the devices according to the present invention generally may be used in the field of building, construction and cartography. Thus, generally, one or more devices according to the present invention may be used in order to measure and/or monitor environmental areas, e.g. countryside or buildings. Therein, one or more devices according to the present invention may be combined with other methods and devices or can be used solely in order to monitor progress and accuracy of building projects, changing objects, houses, etc. The devices according to the present invention can be used for generating three-dimensional models of scanned environments, in order to construct maps of rooms, streets, houses, communities or landscapes, both from ground and from air. Potential fields of application may be construction, interior architecture; indoor furniture placement; cartography, real estate management, land surveying or the like. As an example, the devices according to the present invention may be used in multicopters to monitor buildings, agricultural production environments such as fields, production plants, or landscapes, to support rescue operations, or to find or monitor one or more persons or animals, or the like. Further, devices according to the present invention may be used in production environment to measure the length of pipelines, tank volumes or further geometries related to a production plant or reactor.

Further, the devices according to the present invention may be used within an interconnecting network of home appliances such as CHAIN (Cedec Home Appliances Interoperating Network) to interconnect, automate, and control basic appliance-related services in a home, e.g. energy or load management, remote diagnostics, pet related appliances, child related appliances, child surveillance, appliances related surveillance, support or service to elderly or ill persons, home security and/or surveillance, remote control of appliance operation, and automatic maintenance support. Further, the devices according to the present invention may be used in heating or cooling systems such as an air-conditioning system, to locate which part of the room should be brought to a certain temperature or humidity, especially depending on the location of one or more persons. Further, the devices according to the present invention may be used in domestic robots, such as service or autonomous robots which may be used for household chores. The devices according to the present invention may be used for a number of different purposes, such as to avoid collisions or to map the environment, but also to identify a user, to personalize the robot's performance for a given user, for security purposes, or for gesture or facial recognition. As an example, the devices according to the present invention may be used in robotic vacuum cleaners, floor-washing robots, dry-sweeping robots, ironing robots for ironing clothes, animal litter robots, such as cat litter robots, security robots that detect intruders, robotic lawn mowers, automated pool cleaners, rain gutter cleaning robots, window washing robots, toy robots, telepresence robots, social robots providing company to less mobile people, or robots translating and speech to sign language or sign language to speech. In the context of less mobile people, such as elderly persons, household robots with the devices according to the present invention may be used for picking up objects, transporting objects, and interacting with the objects and the user in a safe way. Further the devices according to the present invention may be used in robots operating with hazardous materials or objects or in dangerous environments. As a non-limiting example, the devices according to the present invention may be used in robots or unmanned remote-controlled vehicles to operate with hazardous materials such as chemicals or radioactive materials especially after disasters, or with other hazardous or potentially hazardous objects such as mines, unexploded arms, or the like, or to operate in or to investigate insecure environments such as near burning objects or post disaster areas. Further, devices according to the present invention may be used in robots that assess health functions such as blood pressure, heart rate, temperature or the like.

Further, the devices according to the present invention may be used in household, mobile or entertainment devices, such as a refrigerator, a microwave, a washing machine, a window blind or shutter, a household alarm, an air condition devices, a heating device, a television, an audio device, a smart watch, a mobile phone, a phone, a dishwasher, a stove or the like, to detect the presence of a person, to monitor the contents or function of the device, or to interact with the person and/or share information about the person with further household, mobile or entertainment devices.

The devices according to the present invention may further be used in agriculture, for example to detect and sort out vermin, weeds, and/or infected crop plants, fully or in parts, wherein crop plants may be infected by fungus or insects. Further, for harvesting crops, the devices according to the present invention may be used to detect animals, such as deer, which may otherwise be harmed by harvesting devices. Further, the devices according to the present invention may be used to monitor the growth of plants in a field or greenhouse, in particular to adjust the amount of water or fertilizer or crop protection products for a given region in the field or greenhouse or even for a given plant. Further, in agricultural biotechnology, the devices according to the present invention may be used to monitor the size and shape of plants. Further, devices according to the present invention may be used in in farming or animal breeding environments such as to clean stables, in automated milk stanchions, in processing of weeds, hay, straw or the like, in obtaining eggs, in mowing crop, weeds or grass, in slaughtering animals, in plucking birds, or the like.

Further, the devices according to the present invention may be combined with sensors to detect chemicals or pollutants, electronic nose chips, microbe sensor chips to detect bacteria or viruses or the like, Geiger counters, tactile sensors, heat sensors, or the like. This may for example be used in constructing smart robots which are configured for handling dangerous or difficult tasks, such as in treating highly infectious patients, handling or removing highly dangerous substances, cleaning highly polluted areas, such as highly radioactive areas or chemical spills, or for pest control in agriculture.

Further, devices according to the present invention may be used in security application such as monitoring an area for suspicious objects, persons or behavior.

One or more devices according to the present invention can further be used for scanning of objects, such as in combination with CAD or similar software, such as for additive manufacturing and/or 3D printing. Therein, use may be made of the high dimensional accuracy of the devices according to the present invention, e.g. in x-, y- or z-direction or in any arbitrary combination of these directions, such as simultaneously. Further, the devices according to the present invention may be used in inspections and maintenance, such as pipeline inspection gauges. Further, in a production environment, the devices according to the present invention may be used to work with objects of a badly defined shape such as naturally grown objects, such as sorting vegetables or other natural products by shape or size or cutting products such as meat, fruit, bread, tofu, vegetables, eggs, or the like, or objects that are manufactured with a precision that is lower than the precision needed for a processing step. As a non-limiting example, devices according to the present invention may be used to sort out natural products of minor quality before or after a packaging step in a production environment.

Further the devices according to the present invention may be used in local navigation systems to allow autonomously or partially autonomously moving vehicles or multicopters or the like through an indoor or outdoor space. A non-limiting example may comprise vehicles moving through an automated storage for picking up objects and placing them at a different location. Indoor navigation may further be used in shopping malls, retail stores, museums, airports, or train stations, to track the location of mobile goods, mobile devices, baggage, customers or employees, or to supply users with a location specific information, such as the current position on a map, or information on goods sold, or the like. Further, the devices according to the present invention may be used in a manufacturing environment for picking up objects such as with a robot arm and placing them somewhere else, such as on a conveyor belt. As a no limiting example a robot arm in combination with one or more devices according to the present invention may pick up a screw from a box and screw it into a specific position of an object transported on a conveyor belt.

Further, the devices according to the present invention may be used to ensure safe driving of motorcycles such as driving assistance for motorcycles by monitoring speed, inclination, upcoming obstacles, unevenness of the road, or curves or the like. Further, the devices according to the present invention may be used in trains or trams to avoid collisions.

Further, the devices according to the present invention may be used in handheld devices, such as for scanning packaging or parcels to optimize a logistics process. Further, the devices according to the present invention may be used in further handheld devices such as personal shopping devices, RFID-readers, handheld devices for use in hospitals or health environments such as for medical use or to obtain, exchange or record patient or patient health related information, smart badges for retail or health environments, or the like.

As outlined above, the devices according to the present invention may further be used in manufacturing, quality control or identification applications, such as in product identification or size identification (such as for finding an optimal place or package, for reducing waste etc.). Further, the devices according to the present invention may be used in logistics applications. Thus, the devices according to the present invention may be used for optimized loading or packing containers or vehicles. Further, the devices according to the present invention may be used for monitoring or controlling of surface damages in the field of manufacturing, for monitoring or controlling rental objects such as rental vehicles, and/or for insurance applications, such as for assessment of damages. Further, the devices according to the present invention may be used for identifying a size of material, object or tools, such as for optimal material handling, especially in combination with robots. Further, the devices according to the present invention may be used for process control in production, e.g. for observing filling level of tanks. Further, the devices according to the present invention may be used for maintenance of production assets like, but not limited to, tanks, pipes, reactors, tools etc. Further, the devices according to the present invention may be used for analyzing 3D-quality marks. Further, the devices according to the present invention may be used in manufacturing tailor-made goods such as tooth inlays, dental braces, prosthesis, clothes or the like. The devices according to the present invention may also be combined with one or more 3D-printers for rapid prototyping, 3D-copying or the like. Further, the devices according to the present invention may be used for detecting the shape of one or more articles, such as for anti-product piracy and for anti-counterfeiting purposes.

Preferably, for further potential details of the optical detector, the method, the human-machine interface, the entertainment device, the tracking system, the camera and the various uses of the detector, in particular with regard to the transfer device, the longitudinal optical sensors, the evaluation device and, if applicable, to the transversal optical sensor, the modulation device, the illumination source and the imaging device, specifically with respect to the potential materials, setups and further details, reference may be made to one or more of WO 2012/110924 A1, US 2012/206336 A1, WO 2014/097181 A1, and US 2014/291480 A1, the full content of all of which is herewith included by reference.

The above-described detector, the method, the human-machine interface and the entertainment device and also the proposed uses have considerable advantages over the prior art. Thus, generally, a simple and, still, efficient detector for an accurate determining a position of at least one object in space may be provided. Therein, as an example, three-dimensional coordinates of an object or a part thereof may be determined in a fast and efficient way.

As compared to devices known in the art, the detector as proposed provides a high degree of simplicity, specifically with regard to an optical setup of the detector. Thus, a single longitudinal optical sensor is sufficient for an unambiguous position detection. This high degree of simplicity, is specifically suited for machine control, such as in human-machine interfaces and, more preferably, in gaming, tracking, scanning, and a stereoscopic vision. Thus, cost-efficient entertainment devices may be provided which may be used for a large number of gaming, entertaining, tracking, scanning, and stereoscopic vision purposes.

Summarizing, in the context of the present invention, the following embodiments are regarded as particularly preferred:

Embodiment 1: A detector for an optical detection of at least one object, comprising:
at least one longitudinal optical sensor, wherein the longitudinal optical sensor has at least one sensor region, wherein the longitudinal optical sensor is designed to generate at least one longitudinal sensor signal in a manner dependent on an illumination of the sensor region by a light beam, wherein the longitudinal sensor signal, given the same total power of the illumination, is dependent on a beam cross-section of the light beam in the sensor region;
at least one transfer device, wherein the transfer device exhibits at least two different focal lengths in response to at least one incident light beam, wherein the transfer device is adapted to adjust the beam cross-section of at least one first light beam having a first wavelength and at least one second light beam having a second wave-length different from the first wavelength depending on the wavelength of respective light beams, such that in the sensor region, the beam cross-section of the first light beam is different from the beam cross-section of the second light beam; and
at least one evaluation device, wherein the evaluation device is adapted to differentiate the longitudinal sensor signal of the longitudinal optical sensor into a first longitudinal sensor signal dependent on the illumination of the sensor region by the first light beam and into a second longitudinal sensor signal dependent on the illumination of the sensor region by the second light beam, wherein the evaluation device is designed to generate at least one item of information on a longitudinal position of the object by evaluating the first longitudinal sensor signal and the second longitudinal sensor signal.

Embodiment 2: The detector according to the preceding embodiment, wherein the transfer device comprises one or more optical lenses having a wavelength dependent refractive index.

Embodiment 3: The detector according to any one of the preceding embodiments, wherein the transfer device is adapted to separate the first light beam and second light beam depending on the wavelength of the light beam, such that the beam cross-section of the light beams in the sensor region is different.

Embodiment 4: The detector according to any one of the preceding embodiments, wherein the detector comprises one longitudinal optical sensor.

Embodiment 5: The detector according to any one of the preceding embodiments, wherein the detector further comprises at least one illumination source adapted to emit at least one light beam.

Embodiment 6: The detector according to the preceding embodiment, wherein the illumination source is adapted to emit at least one light beam comprising at least two different wavelengths, wherein the light beam comprises at least one first portion and at least one second portion having different wavelengths.

Embodiment 7: The detector according to any one of the two preceding embodiments, wherein the illumination source is adapted to emit at least two light beams having different wavelengths.

Embodiment 8: The detector according to any one of the three preceding embodiments, wherein the illumination source comprises at least two light sources.

Embodiment 9: The detector according to the preceding embodiment, wherein the illumination source comprises a first light source and a second light source, wherein the first light source is adapted to emit the first light beam and the second light source is adapted to emit the second light beam.

Embodiment 10: The detector according to any one of the three preceding embodiments, wherein the illumination source comprises one of a bi-color target adapted to emit light with two different wavelengths or a multi-color target adapted to emit light with a plurality of wavelengths.

Embodiment 11: The detector according to any one of the four preceding embodiments, wherein the illumination source comprises at least one aperture element.

Embodiment 12: The detector according to any one of the preceding embodiments, wherein the evaluation de-vice is designed to differentiate the first longitudinal sensor signal and the second longitudinal sensor signal by one or more of a modulation, a frequency or phase shift.

Embodiment 13: The detector according to any one of the preceding embodiments, wherein the evaluation device is designed to resolve ambiguities by considering the first longitudinal sensor signal and the second longitudinal sensor signal.

Embodiment 14: The detector according to any one of the preceding embodiments, wherein the detector furthermore has at least one modulation device for modulating the illumination.

Embodiment 15: The detector according to any one of the preceding embodiments, wherein the first light beam and the second light beam are modulated light beams.

Embodiment 16: The detector according to the preceding embodiment, wherein the detector is designed to detect at least two longitudinal sensor signals in the case of different modulations, in particular at least two sensor signals at respectively different modulation frequencies, wherein the evaluation device is designed to generate the at least one item of information on the longitudinal position of the object by evaluating the at least two longitudinal sensor signals.

Embodiment 17: The detector according to any of the preceding embodiments, wherein the longitudinal optical sensor is furthermore designed in such a way that the longitudinal sensor signal, given the same total power of the illumination, is dependent on a modulation frequency of a modulation of the illumination.

Embodiment 18: The detector according to any of the five preceding embodiments, wherein the modulation device is adapted to modulate the illumination, such that the first light beam and the second light beam have a phase shift.

Embodiment 19: The detector according to any of the preceding embodiments, wherein the evaluation device is adapted to normalize the longitudinal sensor signals and to generate the information on the longitudinal position of the object independent from an intensity of the light beam.

Embodiment 20: The detector according to any of the preceding embodiments, wherein the evaluation device is adapted to generate the at least one item of information on the longitudinal position of the object by determining a diameter of the light beam from the at least one longitudinal sensor signal.

Embodiment 21: The detector according to any one of the preceding embodiments, further comprising at least one transversal optical sensor, the transversal optical sensor being adapted to determine a transversal position of the light beam traveling from the object to the detector, the transversal position being a position in at least one dimension perpendicular to an optical axis of the detector, the transversal optical sensor being adapted to generate at least one transversal sensor signal, wherein the evaluation device is further designed to generate at least one item of information on a transversal position of the object by evaluating the transversal sensor signal.

Embodiment 22: The detector according to any one of the preceding embodiments, wherein the detector comprises at least one imaging device.

Embodiment 23: A detector system for determining a position of at least one object, the detector system comprising at least one detector according to any one of the preceding embodiments, the detector system further comprising at least one beacon device adapted to direct at least one light beam towards the detector, wherein the beacon device is at least one of attachable to the object, holdable by the object and integratable into the object.

Embodiment 24: The detector system according to the preceding embodiment, wherein the detector system comprises at least two beacon devices, wherein at least one property of a light beam emitted by a first beacon device is different from at least one property of a light beam emitted by a second beacon device.

Embodiment 25: The detector system according to any one of the two preceding embodiments, wherein the light beam of the first beacon device and the light beam of second beacon device are emitted simultaneously or sequentially.

Embodiment 26: A method for an optical detection of at least one object, in particular using a detector according to any of the preceding embodiments relating to a detector, comprising the following steps:
adjusting a beam cross-section of at least one first light beam and of at least one second light beam, wherein the first light beam has a first wavelength and the second light beam has a second wavelength different from the first wavelength, such that in the sensor region the beam cross-section of the first light beam is different from the beam cross-section of the second light beam;
generating at least one longitudinal sensor signal by using at least one longitudinal optical sensor, wherein the longitudinal sensor signal is dependent on an illumination of a sensor region of the longitudinal optical sensor by a light beam, wherein the longitudinal sensor signal, given the same total power of the illumination, is dependent on a beam cross-section of the light beam in the sensor region;
evaluating the longitudinal sensor signal by using at least one evaluation device, wherein the longitudinal sensor signal of the longitudinal optical sensor is differentiated into a first longitudinal sensor signal dependent on the illumination of the sensor region by the first light beam and a second longitudinal sensor signal dependent on the illumination of the sensor region by the second light beam, and generating at least one item of information on a longitudinal position of the object by evaluating the first longitudinal sensor signal and the second longitudinal sensor signal.

Embodiment 27: The method according to the preceding embodiment, wherein the method further comprises modulating the first light beam and the second light beam.

Embodiment 28: The method according to any one of the two preceding embodiments, wherein the longitudinal optical sensor signal is evaluated unambiguously.

Embodiment 29: A human-machine interface for exchanging at least one item of information between a user and a machine, wherein the human-machine interface comprises at least one detector system according to any one of the preceding embodiments referring to a detector system, wherein the at least one beacon device is adapted to be at least one of directly or indirectly attached to the user and held by the user, wherein the human-machine interface is designed to determine at least one position of the user by means of the detector system, wherein the human-machine interface is designed to assign to the position at least one item of information.

Embodiment 30: An entertainment device for carrying out at least one entertainment function, wherein the entertainment device comprises at least one human-machine interface according to the preceding embodiment, wherein the entertainment device is designed to enable at least one item of information to be input by a player by means of the human-machine interface, wherein the entertainment device is designed to vary the entertainment function in accordance with the information.

Embodiment 31: A tracking system for tracking a position of at least one movable object, the tracking system comprising at least one detector system according to any one of the preceding embodiments referring to a detector system, the tracking system further comprising at least one track controller, wherein the track controller is adapted to track a series of positions of the object at specific points in time.

Embodiment 32: A scanning system for determining at least one position of at least one object, the scanning system comprising at least one detector according to any of the preceding embodiments referring to a detector, the scanning system further comprising at least one illumination source adapted to emit at least one light beam configured for an illumination of at least one dot located at at least one surface of the at least one object, wherein the scanning system is designed to generate at least one item of information about the distance between the at least one dot and the scanning system by using the at least one detector.

Embodiment 33: A camera for imaging at least one object, the camera comprising at least one detector according to any one of the preceding embodiments referring to a detector.

Embodiment 34: A use of the detector according to any one of the preceding embodiments relating to a detector, for a purpose of use, selected from the group consisting of: a position measurement in traffic technology; an entertainment application; a security application; a surveillance application; a safety application; a human-machine interface application; a tracking application; a photography application; a use in combination with at least one time-of-flight detector; a use in combination with a structured light source; a use in combination with a stereo camera; a machine vision application; a robotics application; a quality control application; a manufacturing application; a use in combination with a structured illumination source; a use in combination with a stereo camera; a use in an active target distance measurement setup.

### BRIEF DESCRIPTION OF THE FIGURES

Further optional details and features of the invention are evident from the description of preferred exemplary embodiments which follows in conjunction with the dependent claims. In this context, the particular features may be implemented alone or with several in combination. The invention is not restricted to the exemplary embodiments. The exemplary embodiments are shown schematically in the figures. Identical reference numerals in the individual figures refer to identical elements or elements with identical function, or elements which correspond to one another with regard to their functions.

Specifically, in the figures:

FIG. 1 shows a schematic setup of an exemplary embodiment of a detector to the present invention; and

FIG. 2 shows an exemplary embodiment of a detector, a detector system, a human-machine interface, an entertainment device and a tracking system according to the present invention.

### EXEMPLARY EMBODIMENTS

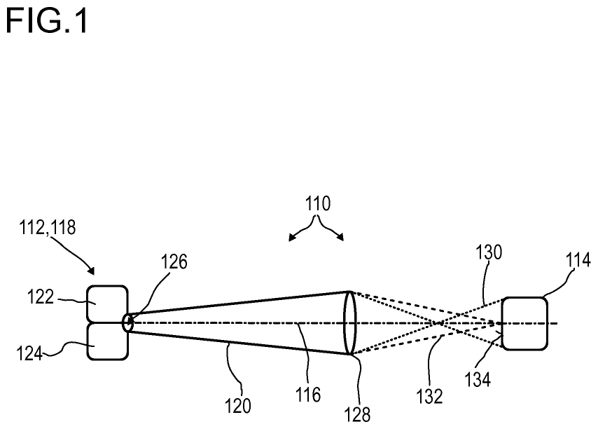

FIG. 1 illustrates, in a highly schematic fashion, an exemplary embodiment of an optical detector 110 according to the present invention, for determining a position of at least one object 112. However, other embodiments are feasible. The optical detector 110 comprises at least one longitudinal optical sensor 114, which, in this particular embodiment, is arranged along an optical axis 116 of the detector 110. Specifically, the optical axis 116 may be an axis of symmetry and/or rotation of the setup of the optical sensor 114. The detector 110 may comprise at least one illumination source 118 adapted to emit at least one light beam 120. The light beam 120 may comprise at least two different wavelengths, wherein the light beam may comprise at least one first portion and at least one second portion having different wavelengths.

The illumination source 118 may be connected to the object 112 or even be part of the object 112, such that, by way of example, the electromagnetic radiation emerging from the object 112 can also be generated directly by the illumination source 118. By way of example, at least one illumination source 118 can be arranged on and/or in the object 112 and directly generate the light beam 120.

The light beam 120 may be generated by the illumination source 118, which may include an ambient light source and/or an artificial light source, such as at least one laser source and/or at least one incandescent lamp and/or at least one semiconductor light source, for example, at least one light-emitting diode, in particular an organic and/or inorganic light-emitting diode. The illumination source may comprise at least one laser source. In FIG. 1, the illumination source 118 may comprise at least one first light source 122 and at least one second light source 124 such as two light emitting diodes and/or two laser diodes. The first light source 122 may be adapted to generate and to emit light with a wavelength λ1 and the second light source 124 may be adapted to generate and to emit light with a wavelength λ2 different from λ1. Thus, the light beam 120 may comprise at least one first portion with wavelength λ1 and at least one second portion with wavelength λ2.

The illumination source 118 may comprise at least one aperture element 126. The aperture element 126 may be a light emitting aperture element.

The detector 110 may further comprise at least one transfer device 128. The transfer device 128 may exhibit at least two different focal lengths in response to the light beam 120. The transfer device 128 is adapted to adjust a beam cross-section of a first light beam 130 having the first wavelength, e.g. λ1, and the second light beam 132 having the second wavelength different from the first wavelength, e.g. λ2, depending on the wavelength of respective light beams 130, 132, such that in a sensor region 134 of the longitudinal optical sensor 114 the beam cross-section of the first light beam 130 is different from the beam cross-section of the second light beam 132. The transfer device 128 may comprise one or more optical lenses having a wavelength dependent refractive index. Particularly in the case where the transfer device 128 comprises a refractive lens, the different focal lengths in the transfer device 128 may be created by a chromatic aberration caused by a material used in the transfer device 128. The transfer device 128 may be or may comprise a lens with strong chromatic aberration. The transfer device 128 may be adapted to separate the first light beam 130 and second light beam 132 depending on the wavelength of the light beams such that the beam cross-section of the light beams in the sensor region 134 is different. In FIG. 1, the light beam 120 may impinge on the transfer device 128. The transfer device 128 may be adapted to separate the portion of the light beam 120 having the first wavelength λ1 from the portion of the light beam 120 having the second wavelength λ2 into the first light beam 130 and the second light beam 132. The first light beam 130 having the first wavelength may have the first beam cross-section in the sensor region 134 and second light beam 132 may have the second beam cross-section different from the first beam cross-section in the sensor region 134.

The first light beam 130 and the second light beam 132 may impinge on the longitudinal optical sensor 114. The longitudinal optical sensor 114 has the at least one sensor region 134. The longitudinal optical sensor 114 is designed to generate at least one longitudinal sensor signal in a manner dependent on an illumination of the sensor region 134 by a light beam, wherein the longitudinal sensor signal, given the same total power of the illumination, is dependent on a beam cross-section of the light beam in the sensor region 134. The first light beam 130 and the second light beam 132 may generate two spots with different spot sizes on the sensor region 134 of the longitudinal optical sensor 114. The first light beam 130 and the second light beam 132 impinging on the sensor region 134 of the longitudinal optical sensor 114 may have different beam cross-sections. The longitudinal optical sensor 114 may generate a longitudinal sensor signal which depends on and/or is generated by the illumination of the sensor region 134 by the first light beam 130 and the second light beam 132. The longitudinal sensor signal may comprise a first portion dependent on and/or is generated by the illumination of the sensor region 134 by the first light beam 130 and a second portion generated by the illumination of the sensor region 134 by the second light beam 132.

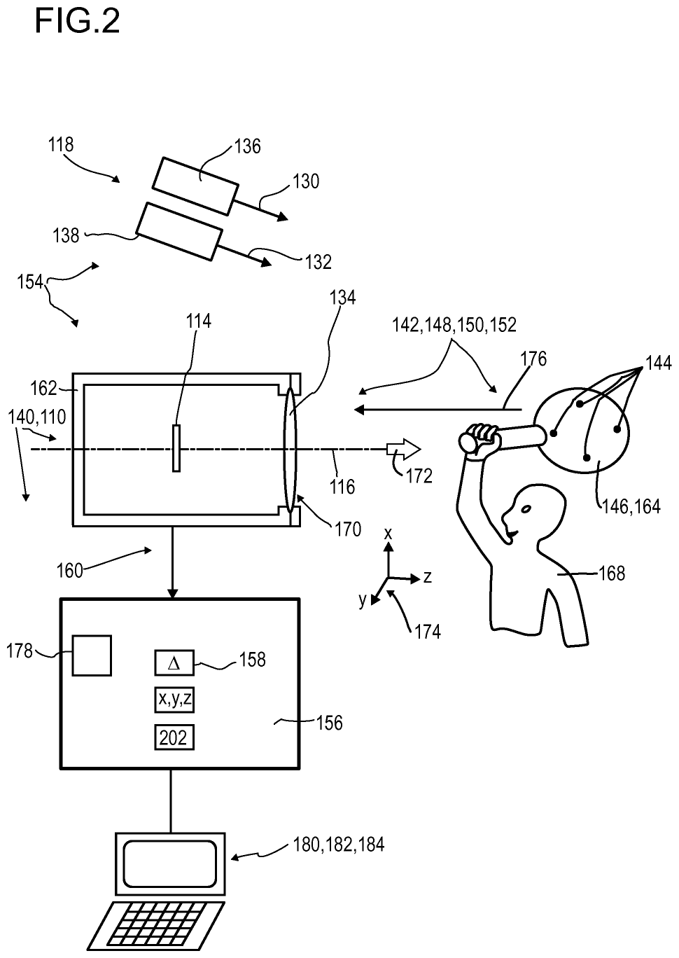

FIG. 2 shows, in a highly schematic illustration, an exemplary embodiment of a detector 110, having at least one longitudinal optical sensor 114 and at least one illumination source 118. The illumination source 118 may comprise a first light source 136 and the second light source 138. The first light source 136 may be adapted to generate the first light beam 130. The second light source 138 may be adapted to generate the second light beam 132.

The detector 110 specifically may be embodied as a camera 140 or may be part of a camera 140. The camera 140 may be made for imaging, specifically for 3D imaging, and may be made for acquiring standstill images and/or image sequences such as digital video clips. Other embodiments are feasible.

FIG. 2 further shows an embodiment of a detector system 142, which, besides the at least one detector 110, comprises one or more beacon devices 144, which, in this exemplary embodiment, are attached and/or integrated into an object 146, the position of which shall be detected by using the detector 110. FIG. 2 further shows an exemplary embodiment of a human-machine interface 148, which comprises the at least one detector system 142, and, further, an entertainment device 150, which comprises the human-machine interface 148. The figure further shows an embodiment of a tracking system 152 for tracking a position of the object 146, which comprises the detector system 142. The components of the devices and systems shall be explained in further detail in the following.

FIG. 2 further shows an exemplary embodiment of a scanning system 154 for determining at least one position of the at least one object 146. The scanning system 154 comprises the at least one detector 110 and, further, the at least one illumination source 118. The first light beam 130 and the second light beam 132 may be configured for an illumination of at least one dot (e.g. a dot located on one or more of the positions of the beacon devices 144) located at at least one surface of the at least one object 146. The scanning system 154 is designed to generate at least one item of information about the distance between the at least one dot and the scanning system 154, specifically the detector 110, by using the at least one detector 110.

As outlined above, an exemplary embodiment of a detector 110 which may be used in the setup of FIG. 2 is shown in FIG. 1. The detector 110 comprises at least one evaluation device 156, having e.g. at least one subtracting device 158, as symbolically depicted in FIG. 2. The components of the evaluation device 156 may fully or partially be integrated into at least one or all of or even each of the longitudinal optical sensors 114 or may fully or partially be embodied as separate components.

The longitudinal optical sensor 114 and one or more of the components of the evaluation device 156 may be interconnected by one or more connectors 160 and/or one or more interfaces, as symbolically depicted in FIG. 2. Further, the optional at least one connector 160 may comprise one or more drivers and/or one or more devices for modifying or preprocessing sensor signals. Further, instead of using the at least one optional connector 160, the evaluation device 156 may fully or partially be integrated into a housing 162 of the detector 110. Additionally or alternatively, the evaluation device 156 may fully or partially be designed as a separate device.

The evaluation device 156 is, generally, designed to generate at least one item of information on a position of the object 112, 146 by evaluating the sensor signal of the longitudinal optical sensor 114. For this purpose, the evaluation device 156 may comprise one or more electronic devices and/or one or more software components, in order to evaluate the sensor signals, which are symbolically denoted by a longitudinal evaluation unit (denoted by “z”). The evaluation device 156 may be adapted to determine the at least one item of information on the longitudinal position of the object 112, 146 by comparing more than one longitudinal sensor signals of the longitudinal optical sensor 114.

The evaluation device 156 is adapted to differentiate, for example to separate and/or to assign, the longitudinal sensor signal of the longitudinal optical sensor 114 into a first longitudinal sensor signal dependent on the illumination of the sensor region 134 by the first light beam 130 and a second longitudinal sensor signal dependent on the illumination of the sensor region 134 by the second light beam 132, wherein the evaluation device 156 is designed to generate at least one item of information on a longitudinal position of the object 112, 146 by evaluating the first longitudinal sensor signal and the second longitudinal sensor signal.

The evaluation device 156 may be designed to differentiate the first longitudinal sensor signal and the second longitudinal sensor signal by one or more of a modulation, a frequency or phase shift. Thus, the evaluation device 156 may be designed to separate and/or determine the portion of the longitudinal sensor signal generated by the first light beam 130 and the portion of the longitudinal sensor signal generated by the second light beam 132. The evaluation device 156 may be designed to generate the at least one item of information on the longitudinal position of the object 112, 146 by evaluating the at least two longitudinal sensor signals. The evaluation device 156 may be adapted to generate the at least one item of information on the longitudinal position of the object 112, 146 by determining a diameter of the light beam from the at least one longitudinal sensor signal.

In this exemplary embodiment, the object 146, the position of which may be detected, may be designed as an article of sports equipment and/or may form a control element or a control device 164, the position of which may be manipulated by a user 168. As an example, the object 146 may be or may comprise a bat, a racket, a club or any other article of sports equipment and/or fake sports equipment. Other types of objects 146 are possible. Further, the user 168 himself or herself, may be considered as the object, the position of which shall be detected.

Further, as outlined above, the detector 110 comprises the transfer device 134. An opening 170 inside the housing 162, which, preferably, is located concentrically with regard to the optical axis 116 of the detector 110, preferably defines a direction of view 172 of the detector 110. A coordinate system 174 may be defined, in which a direction parallel or antiparallel to the optical axis 116 is defined as a longitudinal direction, whereas directions perpendicular to the optical axis 116 may be defined as transversal directions. In the coordinate system 174, symbolically depicted in FIG. 2, a longitudinal direction is denoted by z, and transversal directions are denoted by x and y, respectively. Other types of coordinate systems 174 are feasible.

One or more light beams, in particular the first light beam 130 and the second light beam 132, may propagate from the object 146 and/or from one or more of the beacon devices 144 towards the detector 110, denoted symbolically by reference number 176. The detector 110 is adapted for determining a position of the at least one object 146. The first light beam 130 and the second light beam 132 after being adjusted by the transfer device 128 create two light spots on the sensor region 134.

The illumination source 118 may be a modulated light source, wherein one or more modulation properties of the illumination source 118 may be controlled by at least one optional modulation device 178. Alternatively or in addition, the modulation may be effected in a beam path between the illumination source 118 and the object 146 and/or between the object 164 and the longitudinal optical sensor 114. Further possibilities may be conceivable. The modulation device 178 may be part of the evaluation device 156 or may be designed as a separate device. For example, the first light beam 130 and the second light beam 132 may be modulated light beams. The light beams 130, 132 may be modulated by one or more modulation frequencies. For example, a focus of the light beam may be adjustable, in particular changeable, by modulating the light beam using one or more modulation frequencies. In particular, the light beams 130, 132 may be focused or may be unfocused when impinging on the longitudinal optical sensor 114. The light beams may be modulated by one or more modulation frequencies. For example, a focus of the light beam may be adjustable, in particular changeable, by modulating the light beam using one or more modulation frequencies. In particular, the light beam may be focused or may be unfocused when impinging on the longitudinal optical sensor 114. The modulation device 178 may be adapted to modulate the illumination such that the first light beam 130 and the second light beam 132 have a phase shift. For example, a periodic signal may be used for the light source modulation. For example, the phase shift may be 180° such that a resulting response of the longitudinal optical sensor 114 may be a ratio of the two longitudinal sensor signals. Thereby it may be possible to directly derive a distance from the response of the longitudinal optical sensor 114.

Generally, the evaluation device 156 may be part of a data processing device 180 and/or may comprise one or more data processing devices 180. The data processing device 180 may be or may be part of a machine 182. The evaluation device 156 may be fully or partially integrated into the housing 162 and/or may fully or partially be embodied as a separate device which is electrically connected in a wireless or wire-bound fashion to the longitudinal optical sensor 114. The evaluation device 156 may further comprise one or more additional components, such as one or more electronic hardware components and/or one or more software components, such as one or more measurement units and/or one or more evaluation units and/or one or more controlling units. As outlined above, the determination of a position of the object 112 and/or a part thereof by using the optical detector 110 and/or the detector system 142 may be used for providing a human-machine interface 148, in order to provide at least one item of information to the machine 182. In the embodiments schematically depicted in FIG. 2, the machine 182 may be or may comprise at least one computer and/or a computer system comprising the data processing device 180. Other embodiments are feasible. The evaluation device 156 may be a computer and/or may comprise a computer and/or may fully or partially be embodied as a separate device and/or may fully or partially be integrated into the machine 182, particularly the computer. The same holds true for a track controller 184 of the tracking system 152, which may fully or partially form a part of the evaluation device 156 and/or the machine 182.

Similarly, as outlined above, the human-machine interface 148 may form part of the entertainment device 150. Thus, by means of the user 168 functioning as the object 112 and/or by means of the user 168 handling the object 112 and/or the control element 164 functioning as the object 112, the user 168 may input at least one item of information, such as at least one control command, into the machine 182, particularly the computer, thereby varying the entertainment function, such as controlling the course of a computer game.

### LIST OF REFERENCE NUMBERS

110 detector
112 object
114 longitudinal optical sensor
116 optical axis
118 illumination source
120 light beam
122 first light source
124 second light source
126 aperture element
128 transfer device
130 first light beam
132 second light beam
134 sensor region
136 first light source
138 second light source
140 Camera
142 detector system
144 beacon device
146 object
148 human-machine interface
150 entertainment device
152 tracking system
154 scanning system
156 evaluation device
158 subtracting device
160 connector
162 housing
164 control device
168 user
170 opening
172 direction of view
174 coordinate system
176 light beam
178 modulation device
180 data processing device
182 machine
184 track controller

1. A detector for an optical detection of at least one object, the detector comprising:
at least one longitudinal optical sensor, wherein the longitudinal optical sensor has at least one sensor region, wherein the longitudinal optical sensor is designed to generate at least one longitudinal sensor signal in a manner dependent on an illumination of the sensor region by a light beam, wherein the longitudinal sensor signal, given the same total power of the illumination, is dependent on a beam cross-section of the light beam in the sensor region;
at least one transfer device wherein the transfer device exhibits at least two different focal lengths in response to at least one incident light beam, wherein the transfer device is adapted to adjust the beam cross-section of at least one first light beam having a first wavelength and at least one second light beam having a second wavelength different from the first wavelength depending on the wavelength of respective light beams, such that in the sensor region the beam cross-section of the first light beam is different from the beam cross-section of the second light beam; and
at least one evaluation device, wherein the evaluation device is adapted to differentiate the longitudinal sensor signal of the longitudinal optical sensor into a first longitudinal sensor signal dependent on the illumination of the sensor region by the first light beam and into a second longitudinal sensor signal dependent on the illumination of the sensor region by the second light beam, wherein the evaluation device is designed to generate at least one item of information on a longitudinal position of the object by evaluating the first longitudinal sensor signal and the second longitudinal sensor signal.

2. The detector according to claim 1, wherein the transfer device comprises one or more optical lenses having a wavelength dependent refractive index.

3. The detector according to claim 1, wherein the detector further comprises at least one illumination source adapted to emit at least one light beam.

4. The detector (110) according to claim 3, wherein the illumination source is adapted to emit at least one light beam comprising at least two different wave-lengths, wherein the light beam comprises at least one first portion and at least one second portion having different wavelengths.

5. The detector according to claim 3, wherein the illumination source is adapted to emit at least two light beams having different wavelengths.

6. The detector according to claim 3, wherein the illumination source comprises at least two light sources.

7. The detector according to claim 6, wherein the illumination source comprises a bi-color target adapted to emit light with two different wavelengths or a multi-color target adapted to emit light with a plurality of wavelengths.

8. The detector (110) according to claim 1, wherein the evaluation device is designed to differentiate the first longitudinal sensor signal and the second longitudinal sensor signal by one or more of a modulation, a frequency or phase shift.

9. The detector according to claim 1, further comprising:
at least one modulation device for modulating the illumination.

10. The detector according to claim 1, further comprising:
at least one transversal optical sensor, the transversal optical sensor being adapted to determine a transversal position of the light beam traveling from the object to the detector, the transversal position being a position in at least one dimension perpendicular to an optical axis of the detector, the transversal optical sensor being adapted to generate at least one transversal sensor signal,
wherein the evaluation device is further designed to generate at least one item of information on a transversal position of the object by evaluating the transversal sensor signal.

11. The detector according to claim 1, further comprising:
at least one imaging device.

12. A detector system for determining a position of at least one object, the detector system comprising:
at least one detector according to claim 1, and
at least one beacon device adapted to direct at least one light beam towards the detector wherein the beacon device is at least one of attachable to the object, holdable by the object and integratable into the object.

13. The detector system according to claim 12, comprising at least two beacon devices, wherein at least one property of a light beam emitted by a first beacon device is different from at least one property of a light beam emitted by a second beacon device.

14. A method for an optical detection of at least one object, the method comprising:
adjusting a beam cross-section of at least one first light beam and of at least one second light beam, wherein the first light beam has a first wavelength and the second light beam has a second wavelength different from the first wavelength, such that in a sensor region, the beam cross-section of the first light beam is different from the beam cross-section of the second light beam;
generating at least one longitudinal sensor signal by using at least one longitudinal optical sensor, wherein the longitudinal sensor signal is dependent on an illumination of a sensor region of the longitudinal optical sensor by a light beam, wherein the longitudinal sensor signal, given the same total power of the illumination, is dependent on a beam cross-section of the light beam in the sensor region; and
evaluating the longitudinal sensor signal by using at least one evaluation device, wherein the longitudinal sensor signal of the longitudinal optical sensor is differentiated into a first longitudinal sensor signal dependent on the illumination of the sensor region by the first light beam and a second longitudinal sensor signal dependent on the illumination of the sensor region by the second light beam, and generating at least one item of information on a longitudinal position of the object by evaluating the first longitudinal sensor signal and the second longitudinal sensor signal.

15. The method according to claim 14, further comprising:
modulating the first light beam and the second light beam.

16. A human-machine interface for exchanging at least one item of information between a user and a machine wherein the human-machine interface comprising:
at least one detector system according to claim 12, wherein the at least one beacon device is adapted to be at least one of directly or indirectly attached to the user and held by the user, wherein the human-machine interface is designed to determine at least one position of the user via the detector system and to assign to the position at least one item of information.

17. An entertainment device for carrying out at least one entertainment function, the entertainment device comprising:
at least one human-machine interface according to claim 16,
wherein the entertainment device is designed to enable at least one item of information to be input by a player via the human-machine interface and to vary the entertainment function in accordance with the information.

18. A tracking system for tracking a position of at least one movable object, the tracking system comprising
at least one detector system according to claim 12, and
at least one track controller wherein the track controller is adapted to track a series of positions of the object at specific points in time.

19. A scanning system for determining at least one position of at least one object, the scanning system comprising
at least one detector according to claim 1, and
at least one illumination source adapted to emit at least one light beam configured for an illumination of at least one dot located at at least one surface of the at least one object,
wherein the scanning system is designed to generate at least one item of information about the distance between the at least one dot and the scanning system by using the at least one detector.

20. A camera for imaging at least one object, the camera comprising
at least one detector according to claim 1.

21. (canceled)
